(19) United States
(12) Patent Application Publication
(10) Pub. No.: US 2019/0154931 A1
(43) Pub. Date: May 23, 2019

(54) OPTICAL ASSEMBLIES, INTERCONNECTION SUBSTRATES AND METHODS FOR FORMING OPTICAL LINKS IN INTERCONNECTION SUBSTRATES

(71) Applicant: CORNING OPTICAL COMMUNICATIONS LLC, Hickory, NC (US)

(72) Inventors: Leonard Thomas Masters, Painted Post, NY (US); Robert Adam Modavis, Painted Post, NY (US); James Scott Sutherland, Corning, NY (US)

(21) Appl. No.: 16/253,024

(22) Filed: Jan. 21, 2019

Related U.S. Application Data
(63) Continuation of application No. PCT/US2017/042062, filed on Jul. 14, 2017.
(60) Provisional application No. 62/368,326, filed on Jul. 29, 2016.

(51) Int. Cl. G02B 6/42

(52) U.S. Cl. CPC G02B 6/4206; G02B 6/4227

(57) ABSTRACT

Optical assemblies, interconnection substrates and methods of forming optical links are disclosed. In one embodiment, an optical assembly includes a first waveguide substrate, a second waveguide substrate, and an interconnection substrate having a first end face, a second end face, and a laser written waveguide. The first waveguide substrate is coupled to the first end face of the interconnection substrate, and the first waveguide is optically coupled to the laser written waveguide. The laser written waveguide terminates at the second end face of the interconnection substrate. The second waveguide substrate is coupled to the second end face of the interconnection substrate such that the second waveguide is optically coupled to the laser written waveguide at the second end face.

### PRIORITY APPLICATIONS

This application is a continuation of International Application No. PCT/US17/42062, filed on Jul. 14, 2017, which claims the benefit of priority to U.S. Application No. 62/368,326, filed on Jul. 29, 2016, both applications being incorporated herein by reference.

### BACKGROUND

The present disclosure generally relates to optical communication and, more particularly, to optical assemblies, interconnection substrates and methods for forming optical links employing aligned laser written waveguides.

Benefits of optical fiber include extremely wide bandwidth and low noise operation. Because of these advantages, optical fiber is increasingly being used for a variety of applications, including, but not limited to, broadband voice, video, and data transmission. Connectors are often used in data center and telecommunication systems to provide service connections to rack-mounted equipment and to provide inter-rack connections. Accordingly, optical connectors are employed in both optical cable assemblies and electronic devices to provide an optical-to-optical connection wherein optical signals are passed between an optical cable assembly and an electronic device.

In silicon-based photonic devices, such as hybrid-silicon lasers and silicon optical modulators, optical signals are propagated through the device within optical waveguides. In some laser devices, the laser signals exit the device through a side facet such that the laser signal does not turn prior to being emitted. The alignment of the waveguides at the side facet to a mated optical connector requires an expensive and time consuming active alignment process. Such active alignment processes add significant costs, and severely reduces throughput.

Accordingly, alternative methods and devices for optically coupling waveguides of mated devices are desired.

### SUMMARY

Embodiments of the present disclosure are directed to interconnection substrates for coupling waveguides of external waveguide substrates, as well as methods for forming laser written waveguides within an interconnection substrate such that the laser written waveguides are substantially aligned with the respective external waveguides of attached waveguide substrates. For example, the interconnection substrates described herein may be utilized to optically couple optical fibers to waveguides of a photonics chip.

In this regard, in one embodiment, an optical assembly includes a first waveguide substrate having a first waveguide, a second waveguide substrate having a second waveguide, and an interconnection substrate having a first end face, a second end face, and a laser written waveguide. The first waveguide substrate is coupled to the first end face of the interconnection substrate, and the first waveguide is optically coupled to the laser written waveguide. The laser written waveguide terminates at the second end face of the interconnection substrate. The second waveguide substrate is coupled to the second end face of the interconnection substrate such that the second waveguide is optically coupled to the laser written waveguide at the second end face.

In another embodiment, an interconnection substrate includes a surface, a first end face and a second end face, a pre-written waveguide, a surface combiner waveguide extending from the surface and optically coupled to the pre-written waveguide, and a laser written waveguide optically coupled to an end of the pre-written waveguide and extending toward the second end face.

In yet another embodiment, an optical assembly includes a first waveguide substrate having a first waveguide, a second waveguide substrate having a second waveguide, and an interconnection substrate. The interconnection substrate includes a first end face and a second end face, a pre-written waveguide, and a laser written waveguide. The laser written waveguide is optically coupled to an end of the pre-written waveguide and the end of the laser written waveguide increases in diameter in a direction toward the second end face.

In yet another embodiment, a method of forming an optical link in an interconnection substrate including a first end face coupled to a first waveguide substrate including a first waveguide, and a second end face coupled to a second waveguide substrate includes determining a location of an end of the first waveguide at the first end face, and forming, using a laser, a laser written waveguide within the interconnection substrate extending from the first end face at the location of the end of the first waveguide. The laser written waveguide at least in part defines the optical link.

In yet another embodiment, a method of forming an optical link in an interconnection substrate including an end face coupled to a waveguide substrate includes forming, using a laser, a laser written waveguide within the interconnection substrate, wherein the laser written waveguide at least in part defines the optical link, and detecting, using a detector device, an end of the laser written waveguide within the interconnection substrate.

In yet another embodiment, a method of forming an optical link in an interconnection substrate including an end face coupled to a waveguide substrate includes forming, using a laser, portions of a laser written waveguide within the interconnection substrate. The laser written waveguide at least in part defines the optical link. The method further includes, after an individual portion of the laser written waveguide is formed, coupling light into the laser written waveguide, and detecting, using a detector device, an optical power of light exiting an end the laser written waveguide within the interconnection substrate.

In yet another embodiment, a method of forming an optical link in an interconnection substrate having an end face coupled to a waveguide substrate having a waveguide includes forming, using a laser, a first laser written waveguide within the interconnection substrate, wherein the first laser written waveguide terminates at the end face and has a first index of refraction, coupling light into the first laser written waveguide, detecting, using a detector device, an optical power of light exiting an end the waveguide within the waveguide substrate, and writing one or more additional laser written waveguides within the interconnection substrate. The one or more additional waveguides terminate at the end face, and individual ones of the one or more additional laser written waveguides traverse a different path within the interconnection substrate than the first laser written waveguide and other additional laser written waveguides. Successive additional laser written waveguides have a higher index of refraction than the first index of refraction and indices of refraction of previously formed one or more additional laser written waveguides. The method further includes detecting, using the detector device, an optical power of light exiting an end of the one or more additional laser written waveguides, and selecting an optimal laser written waveguide from the first laser written waveguide and the one or more additional laser written waveguides. The laser written waveguide provides a highest optical power of light among the first laser written waveguide and the one or more additional laser written waveguides.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate embodiments, and together with the description serve to explain principles and operation of the various embodiments.

### BRIEF DESCRIPTION OF THE DRAWINGS

FIG. 1A schematically depicts an example optical assembly including a first waveguide substrate, an interconnection substrate, and a second interconnection substrate in an unassembled state according to one or more embodiments described and illustrated herein;

FIG. 1B schematically depicts the example optical assembly depicted in FIG. 1A in an assembled state wherein the first waveguide substrate is attached to a first end face of the interconnection substrate and the second substrate is attached to a second end face of the interconnection substrate according to one or more embodiments described and illustrated herein;

FIG. 1C schematically depicts the assembled optical assembly depicted in FIG. 1B wherein a laser written waveguide is formed from the first end face at a waveguide of the first waveguide substrate to the second end face at a waveguide of the second waveguide substrate according to one or more embodiments described and illustrated herein;

FIG. 2A schematically depicts an example interconnection substrate having an internal pre-written waveguide according to one or more embodiments described and illustrated herein:

FIG. 2B schematically depicts an example optical assembly in an unassembled state including the example interconnection substrate depicted in FIG. 2A, a first waveguide substrate, and a second waveguide substrate according to one or more embodiments described and illustrated herein;

FIG. 2C schematically depicts the assembled optical assembly depicted in FIG. 2B, the interconnection substrate including a first portion of a laser written waveguide between the pre-written waveguide and a first end face at a waveguide of the first waveguide substrate, according to one or more embodiments described and illustrated herein:

FIG. 2D schematically depicts the assembled optical assembly depicted in FIG. 2B, the interconnection substrate including a second portion of a laser written waveguide between the pre-written waveguide and a second end face at a waveguide of the second waveguide substrate, according to one or more embodiments described and illustrated herein;

FIG. 3A schematically depicts an example interconnection substrate having an internal pre-written waveguide terminating at a second end face according to one or more embodiments described and illustrated herein:

FIG. 3B schematically depicts an example optical assembly in an unassembled state including the example interconnection substrate depicted in FIG. 3A and a second waveguide substrate according to one or more embodiments described and illustrated herein;

FIG. 3C schematically depicts an example optical assembly in an unassembled state including the example interconnection substrate depicted in FIG. 3B, the second waveguide substrate being attached to the second end face of the interconnection substrate, according to one or more embodiments described and illustrated herein;

FIG. 3D schematically depicts an example optical assembly in an unassembled state including the example interconnection substrate depicted in FIG. 3C and further including a first waveguide substrate, according to one or more embodiments described and illustrated herein;

FIG. 3E schematically depicts an example optical assembly in an assembled state including the example interconnection substrate depicted in FIG. 3D wherein the first waveguide substrate is attached to a first end face of the interconnection substrate and a laser written waveguide extends from the pre-written waveguide to the first end face at a waveguide of the first waveguide substrate, according to one or more embodiments described and illustrated herein:

FIG. 4 is an end view of silicon waveguides on a planar substrate:

FIG. 5 is a top down view of silicon waveguides on a planar substrate:

FIG. 6A schematically depicts an optical assembly including an optical fiber and an interconnection substrate having an angled interface according to one or more embodiments described and illustrated herein;

FIG. 6B schematically depicts a close up view of the angled interface depicted in FIG. 6A and further including an adhesive layer configured to fluoresce, according to one or more embodiments described and illustrated herein;

FIG. 7A schematically depicts a substrate having a plurality of fiducial marks according to one or more embodiments described and illustrated herein;

FIG. 7B schematically depicts a substrate having a plurality of fiducial points defining a plurality of lines therein according to one or more embodiments described and illustrated herein;

FIG. 8 schematically depicts an optical fiber probe scanning an end face of a waveguide substrate according to one or more embodiments described and illustrated herein;

FIG. 9 schematically depicts the waveguide substrate depicted in FIG. 8 attached to an interconnection substrate and being scanned by a scanning device according to one or more embodiments described and illustrated herein;

FIG. 10A schematically depicts an example process of forming a laser written waveguide in an example interconnection substrate utilizing multiple imaging devices according to one or more embodiments described and illustrated herein;

FIG. 10B schematically illustrates an example process of using a light scattering structure at an end of the laser written waveguide as it is formed within an interconnection substrate according to one or more embodiments described and illustrated herein;

FIG. 11A schematically depicts an example process of forming a laser written waveguide and fiducial points in an example interconnection substrate utilizing multiple imaging devices according to one or more embodiments described and illustrated herein;

FIG. 11B schematically depicts an example power peaking process implemented using an interconnection substrate attached to an external waveguide substrate according to one or more embodiments described and illustrated herein:

FIG. 12 schematically depicts an example power peaking process implemented using an interconnection substrate having a surface combiner waveguide and attached to an external waveguide substrate according to one or more embodiments described and illustrated herein:

FIG. 13 schematically depicts an example power peaking process implemented using an interconnection substrate having a surface tap waveguide and attached to an external waveguide substrate according to one or more embodiments described and illustrated herein:

FIG. 14A schematically depicts a laser written waveguide having a spiral path in an interconnection substrate implemented in a power peaking process according to one or more embodiments described and illustrated herein;

FIG. 14B schematically depicts a laser written waveguide having a serpentine path in an interconnection substrate implemented in a power peaking process according to one or more embodiments described and illustrated herein;

FIG. 15A graphically depicts simulation data for coupled SMF-28 optical fibers under axial and lateral misalignment according to one or more embodiments described and illustrated herein:

FIG. 15B graphically depicts simulated insertion loss curves as a function of lateral offset for axial separations 0 to 100 μm according to one or more embodiments described and illustrated herein;

FIG. 16A schematically depicts an example power peaking process implemented using an interconnection substrate having a laser written waveguide with a tapered structure, the interconnection substrate being attached to an external waveguide substrate according to one or more embodiments described and illustrated herein:

FIG. 16B schematically depicts an example power peaking process implemented using an interconnection substrate having a laser written waveguide with a tapered structure and a pre-written waveguide with a tapered structure, the interconnection substrate being attached to an external waveguide substrate according to one or more embodiments described and illustrated herein;

FIG. 17A schematically illustrates an example optical assembly including an interconnection substrate attached to an external waveguide substrate according to one or more embodiments described and illustrated herein;

FIG. 17B schematically illustrates the example optical assembly depicted in FIG. 17A further including two overwritten laser written waveguides according to one or more embodiments described and illustrated herein:

FIG. 18 schematically illustrates an optical assembly including an external waveguide substrate attached to an interconnection substrate having multiple overwritten laser written waveguides in a power peaking process according to one or more embodiments described and illustrated herein;

FIG. 19 schematically illustrates an example process of a focused laser forming multiple laser written waveguides using multiple passes of a high aspect ratio focus region in a substrate according to one or more embodiments described and illustrated herein:

FIGS. 20A and 20B schematically illustrate an example power peaking process employing a laser written waveguide having a high aspect ratio according to one or more embodiments described and illustrated herein; and

FIG. 21 schematically illustrates an example interconnection substrate having two alignment waveguides positioned outside an array of optical link waveguides according to one or more embodiments described and illustrated herein.

### DETAILED DESCRIPTION

Embodiments described herein are directed to optical assemblies and interconnection substrates for coupling waveguides of external waveguide substrates, as well as to methods for forming laser written waveguides within an interconnection substrate such that the laser written waveguides are substantially aligned with the respective external waveguides of attached waveguide substrates. Various alignment methodologies are disclosed, such as direct methods of determining waveguide or fiducial locations using vision system techniques prior to or during waveguide formation, use of backlighting to determine waveguide end location, use of power peaking/hill climbing algorithms to find optical convergence of the waveguide end to a target location, and use of multivariable curve fit approaches to find optical convergence of the waveguide end to the target location.

Various embodiments of optical assemblies, interconnection substrates, and methods for forming optical links are described in detail below.

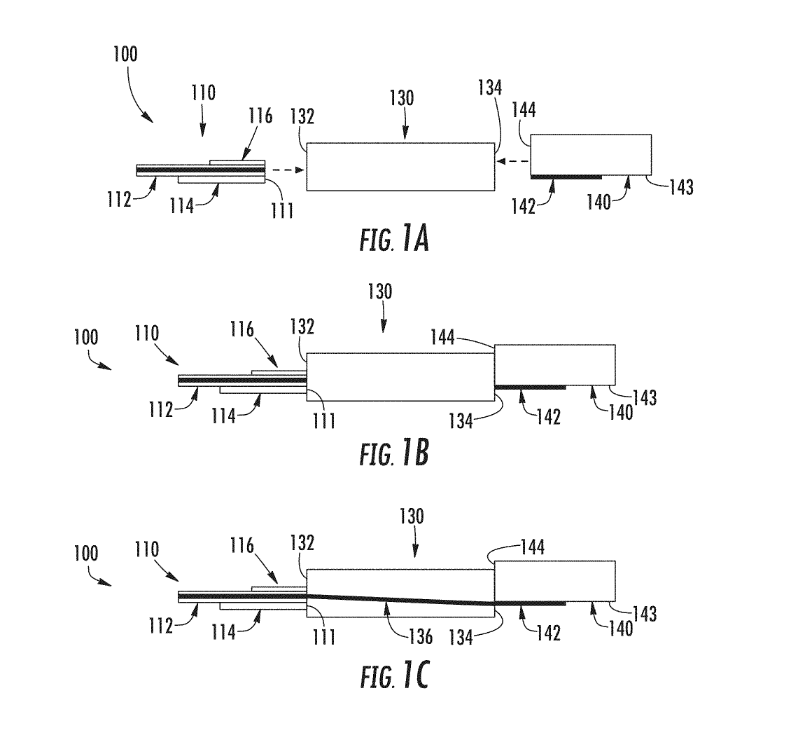

Referring now to FIGS. 1A-IC, an example process for fabricating an example optical assembly 100 according to a first technique is schematically illustrated. The example optical assembly 100 generally comprises a first waveguide substrate 110, an interconnection substrate 130, and a second waveguide substrate 140. In illustrated embodiment, the example first waveguide substrate 110 generally comprises one or more optical fibers 112 supported by a glass substrate 114 and a groove substrate 116, wherein the one or more optical fibers 112 are disposed within one or more grooves (not shown) of the groove substrate 116. The one or more optical fibers 112 define one or more first waveguides of the first waveguide substrate 110. The one or more optical fibers 112 may be configured as any type of optical fiber. The one or more optical fibers 112 may be single mode or multimode optical fibers depending on the end application. The first waveguide substrate 110 further comprises a first edge 111. It should be understood that embodiments are not limited to the first waveguide substrate 110 depicted in FIGS. 1A-1C, and that the first waveguide substrate may take on any structure having at least one waveguide.

The second waveguide assembly 140 generally comprises a base substrate 143 comprising one or more second waveguides 142 at a surface of the base substrate 143. The one or more second waveguides 142 may take on any configuration, such as, without limitation, optical fibers attached to a surface of the base substrate 143, waveguides disposed within a surface or a bulk of base substrate, formed via base substrate etching processes, laser written waveguide, ion-exchanged waveguides, among others. In some embodiments, the base substrate 143 is fabricated from glass. Although the one or more second waveguides 142 are illustrated as being on a surface of the base substrate 143, it should be understood that the one or more waveguides may be disposed within a bulk of the base substrate 143. The base substrate 143 further comprises a second end face 144 that is attached to an edge of the interconnection substrate 130.

In these embodiments, the second waveguide substrate is configured as a photonic assembly comprising one or more active optical components (not shown), such as one or more laser devices and one or more photodetector devices. Accordingly, the one or more second waveguides 142 pass optical signals to and from the one or more active optical components.

It should be understood that the second waveguide assembly may take on configurations other than a photonic assembly. It should also be understood that the interconnection substrates described herein may be utilized to optically couple two or more photonic assemblies, or two or more waveguide assemblies having waveguides configured as optical fibers. As such, embodiments are not limited by the configuration of the first and second waveguide assemblies. As used herein, the term “optically coupled” means that that optical signals may pass between two components.

The interconnection substrate 130 comprises a bulk material having a first end face 132 and a second end face 134. The interconnection substrate 130 may be fabricated from any material that may be laser-written to change an index of refraction of the material to create one or more waveguides to guide optical signals within the interconnection substrate 130. As a non-limiting example, the interconnection substrate 130 may be fabricated from glass, such as a glass sheet formed by a fusion process or a redrawn glass component.

Referring particularly to FIGS. 1A and 1B, the first edge 111 of the first waveguide substrate 110 is brought into contact and attached to the first end face 132 of the interconnection substrate 130. Similarly, the second end face 144 of the second waveguide substrate 140 is brought into contact and attached to the second end face 134 of the interconnection substrate 130. Because the interconnection substrate 130 does not yet have one or more waveguides forming optical links between the waveguides of the first and second waveguide substrates 110, 140, the first and second waveguide substrates 110, 140 need only be coarsely aligned with respect to the first and second end faces 132, 144 of the interconnection substrate 130, respectively. The first and second waveguide substrates 110, 140 may be permanently attached to the first and second end faces 132, 134 of the interconnection substrate, respectively, by an adhesive, such as, without limitation, an ultra-violet (“UV”) curable adhesive that is substantially transparent to the wavelength(s) of the optical signals to be guided within the interconnection substrate 130. The substrates may also be joined via material fusion processes, such as laser welding.

After the first and second waveguide substrates 110, 140 are attached to the interconnection substrate 130, the end locations of the first and second waveguides 112, 142 are determined. Various methods for determining the end locations of the first and second waveguides 112, 142 are described in detail below. In one embodiment, a measurement system determines the exact location of the first and second waveguides 112, 142 on the first and second end faces 132, 134 of the interconnection substrate 130.

Referring to FIG. 1C, one or more laser written waveguides 136 are formed by a laser writing process that locally changes the index of refraction of the material of the interconnection substrate 130. Any known or yet-to-be-developed laser writing process capable of changing the index of refraction along a laser written line to form a waveguide may be utilized.

As shown in FIG. 1C, the one or more laser written waveguides 136 are initiated at the first edge face 132 of the interconnection substrate 130 such that an end of the one or more laser written waveguides 136 is optically coupled to the one or more waveguides 112 of the first waveguide substrate 110. As described in detail below, the end of the one or more first waveguides 112 may be precisely located at the first end face 132 of the interconnection substrate 130 such that optical coupling losses between the one or more first waveguides 112 and the one or more laser written waveguides 136 are minimized. The one or more laser written waveguides 136 are written such that the one or more laser written waveguides 136 terminate at the second end face 134 of the interconnection substrate 130 and are optically coupled to the one or more second waveguides 142 of the second waveguide substrate 140. The ends of the one or more second waveguides 142 at the second end face 134 of the interconnection substrate 130 may be accurately determined by the example processes described below.

The one or more laser written waveguides 136 provide one or more optical links between the one or more first waveguides 112 and the one or more second waveguides 142. Thus, the interconnection substrate 130 optically couples the first waveguide substrate 110 to the second waveguide substrate 140. In the illustrated example, an array of optical fibers serving as first waveguides 112 are optically coupled to an array of second waveguides 142 within or on the base substrate 143 that may be further optically coupled to one or more active optical components, such as laser diodes and photodetectors, for example.

It is noted that the laser written waveguide may bend within the interconnection substrate 130 through a controlled radius curve to limit bend losses while accommodating any lateral shifts that result from coarse alignment and attachment of the first and second waveguide substrates 110, 140 to the interconnection substrate 130. No additional post-write processing steps are required after laser writing is complete.

While FIGS. 1A-1C illustrate normal incidence coupling between the first and second waveguides 112, 142 and the laser written waveguides, it is also possible to overlap the first and/or second waveguide substrate 110, 140 and the interconnection substrate 130 so that the substrates are joined on their respective top/bottom surfaces. This configuration may enable low loss directional coupling or tapered waveguide coupling between substrate waveguides.

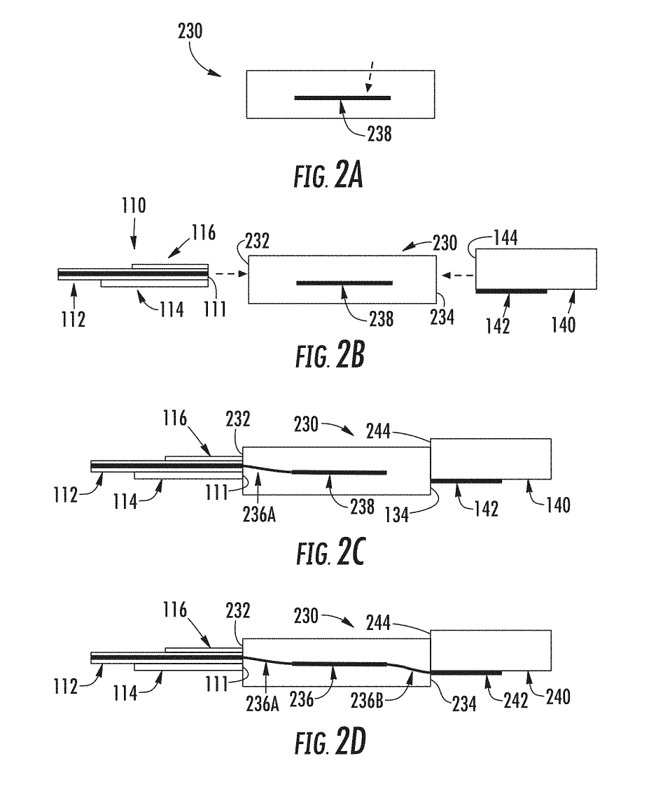

In some cases, it may be desirable to form the interconnection substrate 130 with pre-written internal or surface waveguides, such as the pre-written waveguide 238 as shown in FIG. 2A. As used herein, the term “pre-written waveguide” is any waveguide that is formed prior to attachment of the first and/or second waveguide substrates to the interconnection substrate. These pre-written waveguides may be formed using any process, for example, ion exchange, deposited dielectric, selective substrate material etching, or low-loss laser written waveguide technologies. Pre-written waveguides 238 may be useful for providing low loss optical transport across an interconnection substrate 230 in cases where standard laser written waveguides have propagation losses that are undesirably high. For example, the pre-written waveguides 238 may be designed to provide low optical loss in small radius bends for compact routing of optical waveguides within the interconnection substrate 230.

Referring to FIGS. 2B-2D and as described above with respect to FIGS. 1A-IC, first and second waveguide substrates 110, 140 are coarsely aligned and attached to the first and second end faces 232, 234 of the interconnection substrate (FIGS. 2B and 2C). A measurement technique is used to accurately determine the location of both the external first and second waveguides 112, 142 and the internal pre-written internal waveguides 238. Next, a laser written waveguide portion 236A defining a first optical link is formed between a location of the end of the first waveguide 112 at the first end face 232 and one end of the pre-written waveguide 238 (FIG. 2C). A second laser written waveguide portion 236B defining a second optical link is formed between a location of the end of the second waveguide 142 at the second end face 234 and the other end of the pre-written waveguide 238 (FIG. 2D). Once all optical waveguide links within the interconnection substrate 230 have been written the assembly process is complete.

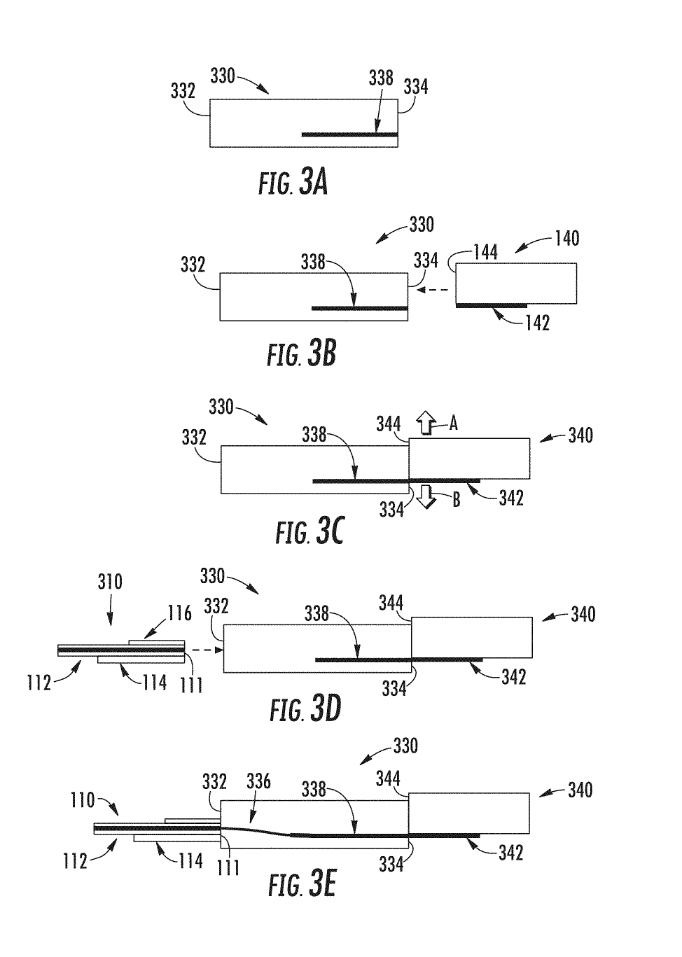

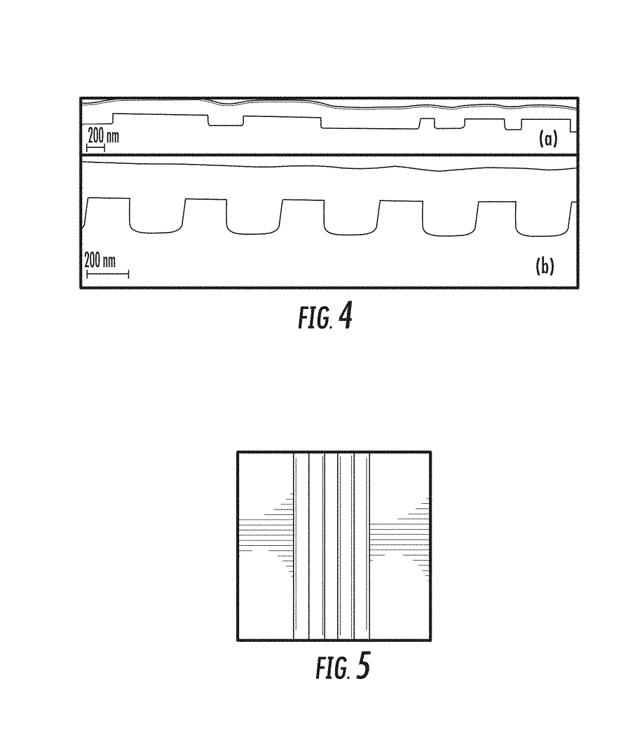

Referring to FIG. 3A, in a hybrid assembly approach, a pre-written waveguide 338 is formed within or on an interconnection substrate 330 so that one end of the pre-written waveguide 338 terminates at one end face of the interconnection substrate 330 (e.g., the second end face 334), while the other end terminates on or within the interconnection substrate 330. Referring to FIGS. 3B and 3C, a waveguide substrate (e.g., the second waveguide substrate 140) is then precision aligned and attached to the interconnection substrate 330. Arrows A and B represent movement of the interconnection substrate 330 and/or the second waveguide substrate 140 to precisely align the second waveguide 142 to the end of the pre-written waveguide 338, where additional lateral alignment into and out of the page (not shown in the figure) may also be required. The second waveguide substrate 140 may be attached to the second end face 334 of the interconnection substrate 330 by an adhesive, for example. The substrates may also be joined via material fusion processes, such as laser welding. This process may be beneficial in cases where, during final assembly, waveguides on the waveguide substrate are not easily accessible. The waveguide substrate and the interconnection substrate may be actively aligned on a dedicated bench using established processes that are both rapid and low cost.

Referring to FIGS. 3D and 3E, the other waveguide substrate (e.g., the first waveguide substrate 110) is coarsely aligned with respect to the interconnection substrate 330 and is attached thereto (e.g., by an adhesive or laser welding). As described above with respect to FIG. 2C, the respective ends of the first waveguide 112 and the pre-written waveguide 338 are determined, and a laser written waveguide 336 is formed therebetween. FIG. 3E depicts a final assembly comprising a first waveguide substrate 110, an interconnection substrate 330, and a second waveguide substrate 140.

Techniques for determining the precise location of external waveguide ends (located on an end face of the interconnection substrate) or pre-written internal waveguide ends prior to the laser written waveguide writing process will now be described. In the techniques described below, once the external or internal waveguide end locations are determined, a computer may calculate a path through the interconnection substrate between the waveguide end locations that minimizes optical loss, and thus a laser written waveguide may be formed along this path. Methods for determining waveguide ends may include, but are not limited to, vision system measurements, correlation of existing waveguide end locations to fiducial marks or reference surfaces/features, and off-line optical coupling measurements.

In one approach, vision system measurements employ two dimensional and three dimensional imaging techniques for determining the location of waveguides within substrates. In one approach, it is possible to observe existing waveguide end locations through substrates for x-axis and y-axis (in-plane) and possibly z-axis (depth) measurement. Depending on waveguide type, the core of the waveguide may be visually well-defined without additional enhancement steps as shown in FIGS. 5A and 5B (e.g., silicon-on-glass waveguides). Depending on how and where the external waveguide ends contact the interconnection substrate, the waveguides may be viewed on end (FIG. 4A) or from above (FIG. 4B).

However, low contrast optical waveguides (e.g. weakly guiding waveguides with an index of refraction of delta <1%) in glass substrates are not always easy to observe, especially in situations where there is not an abrupt step between the core and cladding glass index regions. To increase the waveguide core/cladding contrast, Nomarski Differential Interference Contrast (“DIC”) imaging can be used as shown in FIG. 5A. In this case, the in-plane (XY) position of the waveguide can be determined through digital imaging, while the out-of-plane (Z depth) of the waveguide can be estimated by observing variations in image focus against focal point depth in the substrate.

The accuracy of the out-of-plane depth measurement for a waveguide can be increased using microscopy techniques that automate the acquisition of images at various depths within the substrate, and use digital image processing techniques to resolve the waveguide depth. Examples techniques include, but are not limited to, focus stacking and digital image processing, white light interferometry, confocal microscopy, and depth discrimination of phase shift interferometry (“PSI”).

A variation on the vision system measurement approach is optical tomography, where multiple images of an object of interest are acquired from various vantage points. Computer calculations can use these multiple images to build a three dimensional map of image objects. In quantitative phase tomography, interference measurements are made at multiple observation angles to measure the optical index of refraction at points within a substrate. Referring to FIG. 5B as an example, light may be guided into an end of the waveguide so that its core position is clearly visible when viewed on end (i.e., along the axis of the waveguide) by an imaging system.

In these embodiments, the visibility of a waveguide core may be enhanced to improve the ability to detect the location of the waveguide within the substrate. One method for enhancing the visibility of an optical waveguide includes guiding light into the far end of the waveguide so that the core position is visible when viewed on end (i.e., along the axis of the waveguide) by an imaging system. FIG. 5B is a digital photograph illustrates example waveguides that are visible under back illumination.

The location of waveguides created within a substrate may be enhanced by coupling light into the waveguides at an alternative waveguide excitation wavelength that causes the substrate to locally fluoresce (via a glass composition change) or scatter (due to sidewall roughness effects). This fluoresced or scattered light is detected by an optical imaging system positioned above or below the interconnection substrate to reveal the exact location of the internal waveguides. FIG. 5C is a photograph of enhanced waveguide visibility within a substrate by coupling light into the waveguide at an alternative waveguide excitation wavelength that promotes fluorescence or light scattering.

In some embodiments, a laser written waveguide is initially written so that it scatters light. Then, after the waveguide location is identified as part of a subsequent waveguide laser writing step, the entire initial laser written waveguide may be rewritten using a process that reduces the light scattering structure by smoothing sidewalls of the initial laser written waveguide and/or by increasing the diameter of the initial laser written waveguide.

Further, to enhance visibility of the laser written waveguide end, in some embodiments, light scattering structures are formed at the end of the laser written waveguide. These structures may include tapered structures, local surface roughening, or a waveguide end surfaces that diffract light. Micrometer scale voids or other scattering structures involving large changes in index of refraction may also be incorporated to enhance scattering of light at the waveguide end. The end surface formation may be configured to strongly scatter light in a specific azimuthal direction, such as towards the top or bottom surface of the interconnection substrate or other substrate where imaging equipment may be located, for example.

After the waveguide end having one or more light scattering structures is located (e.g., by an imaging system), the light scattering structures may be eliminated or reduced by writing a laser over the light scattering structure, such as in the process of creating an internal waveguide within an interconnection substrate.

One challenge with optical imaging of waveguide ends that are attached to the side of another substrate is that the waveguide end locations may not be easily resolved when viewed at an angle normal to the substrate. FIG. 5D illustrates how it may be difficult to determine a location of a waveguide end of an optical fiber coupled to a waveguide substrate. The top assembly of FIG. 5D depicts an optical fiber and waveguide substrate without back illumination through the optical fiber, while the bottom assembly of FIG. 5D depicts an optical fiber and waveguide substrate with back illumination through the optical fiber. However, the interface between the external waveguide and the substrate may be angled to improve waveguide core visibility from the top or bottom of the substrate.

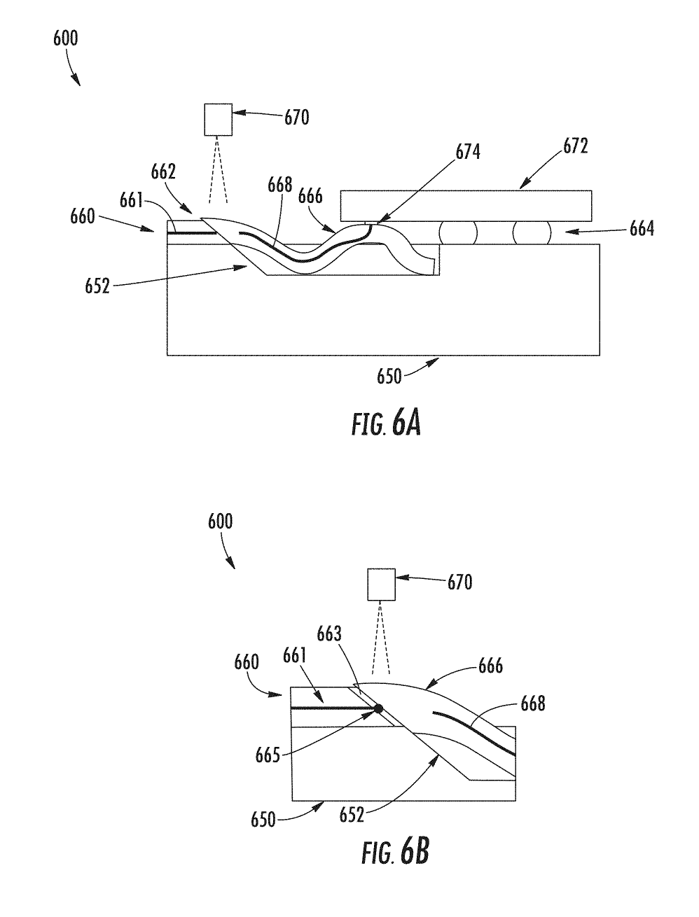

FIG. 6A depicts an example optical assembly 600 that includes a base substrate 650, such as a circuit board substrate, an interconnection substrate 666 within a recess 652 of the base substrate 650, an optical fiber 660 providing a waveguide 661, and a base substrate 672 having a photonic chip 674 on an undersurface. The base substrate 672 in the illustrated example is electrically coupled to the base substrate 650 by solder bumps 664. The interconnection substrate 666 of the illustrated embodiment is configured as curved substrate, such as a flexible glass substrate. However, it should be understood that embodiments are not limited to curved substrate. The interconnection substrate 666 may be retained in the recess 652 by a backfill adhesive, for example. It should be understood that in other embodiments, the base substrate 650 does not include a recess. The interconnection substrate 666 also includes one or more prewritten waveguides 668 for propagating optical signals therein. As shown in FIG. 6A, the interface 662 between the optical fiber 660 and the interconnection substrate 666 is angled with respect to an optical axis of the optical fiber 660 to enhance the visibility of the end of the waveguide 661 of the optical fiber 660 at the interface 662 as detected by the imaging device 670 positioned above the optical assembly 600.

It should be understood that any of the embodiments described herein may include angled interfaces to increase visibility of waveguide ends as well as to reduce back reflections of the optical signals.

The visibility of an external waveguide end on an interconnection substrate may be further enhanced by filling the joint between the external waveguide and the interconnection substrate with a thin layer of adhesive filled with fluorescent polymer material/microspheres that highlight the core location of the waveguide in response to back-illumination. FIG. 6B shows a close up view of the interface 662 depicted in FIG. 6A, wherein an adhesive layer 663 is disposed between the angled facet of the optical fiber 660 and the corresponding angled facet of the interconnection substrate 666. The adhesive layer is filled with a fluorescent polymer material/microspheres that are operable to fluoresce 665 at one or more backlit wavelengths, thereby increasing the visibility of the external waveguide 661 end as detected by the imaging device 670.

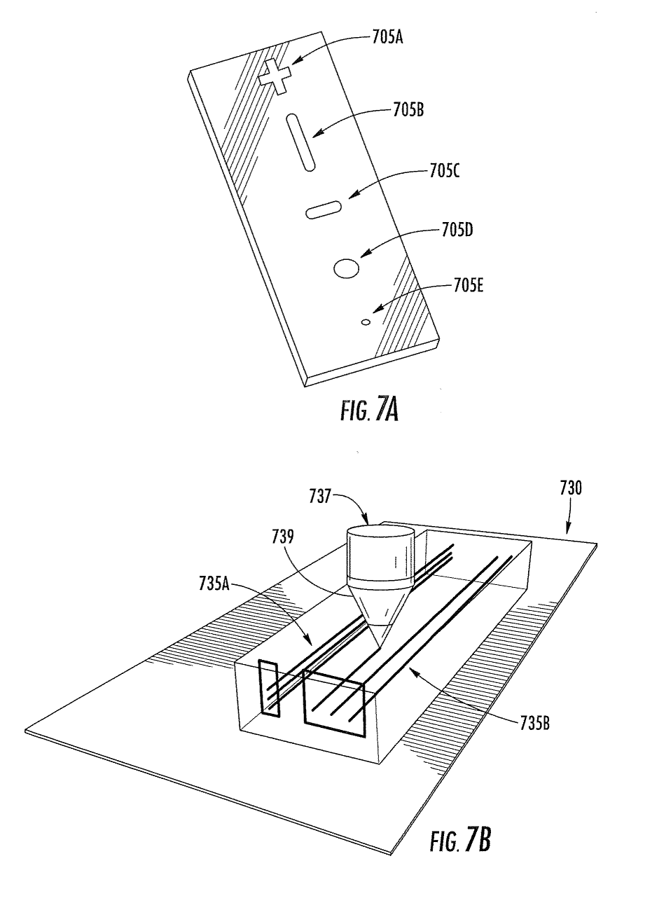

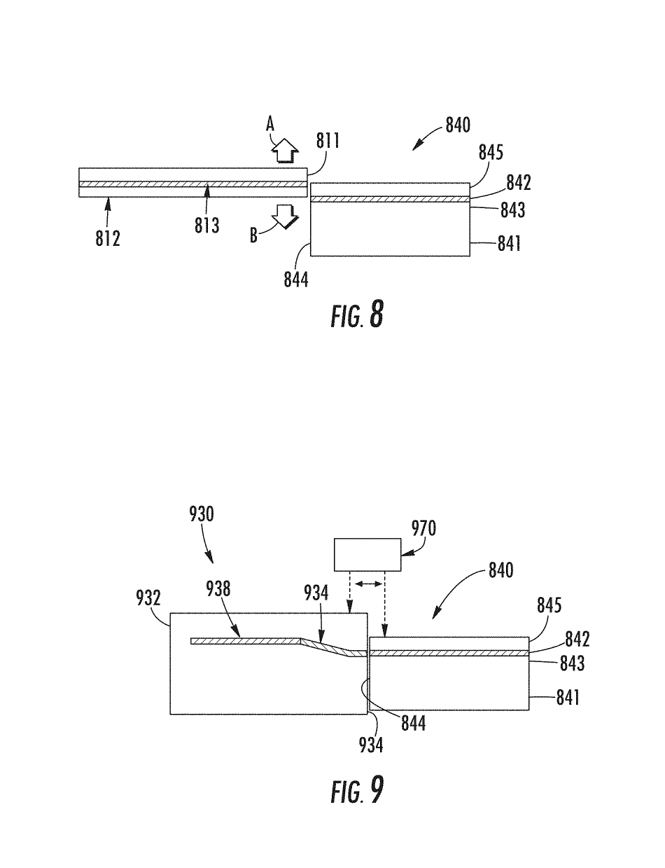

Some waveguide locations may be difficult to image directly using the direct imaging optical techniques described above. In some embodiments, the end locations of waveguides may be correlated to nearby fiducial marks or reference features (XY or XYZ location). FIG. 7A schematically depicts a substrate having a plurality of fiducial marks 705A-705E that may assist a vision system in finding locations of correlated waveguides. These fiducial marks may be fabricated before or after waveguide fabrication. Processes where fiducial marks are fabricated first may be beneficial because the waveguide fabrication process can then create waveguides at a known offset from the fiducial marks. Even if the waveguides are not visible, the fiducial mark provides a reference point that can be identified by subsequent laser written waveguide process equipment. When laser written waveguides are formed, they are written at the same known offset from the fiducial mark that was used to create the initial waveguide, ensuring that the two waveguides will be aligned. The fiducial mark may be in the plane of the waveguide end, or in a different plane where the depth distance between the waveguide planes and the fiducial plane is known.

The fiducial marks may be created by any process, such as, without limitation, a photolithography process or by a laser feature writing processes (e.g., laser ablation or patterning of the base substrate material or an absorbing material placed on top of the base substrate material). High visibility fiducial marks (relative to low contrast waveguide ends) can be fabricated in a deposited photoresist layer, a deposited metallization layer (e.g., Si on glass), or via etched features in the base substrate (e.g., etched features in a base glass substrate).

It is noted that instead of making a direct measurement of the waveguide end depth by, for example, optical microscopy (where the depth is measured relative to datum surfaces of the optical microscope), the waveguide end depth may be measured relative to the surface of the interconnection substrate or a neighboring waveguide substrate. Techniques described above for depth measurements of optical waveguide ends, such as focus stacking and digital image processing, or confocal laser scanning profilometry, may also be applied to configurations that include both a waveguide end and a reference datum surface. In this case, knowing the depth of the waveguide end relative to one or more interconnection substrate surfaces is sufficient for the subsequent formation of laser written waveguides within the interconnection substrate at precise depth locations. Other techniques, including optical microscopy or DIC, may be used to accurately determine the XY in-plane location of the waveguide ends.

Further, fiducial points may be used alone or in combination with fiducial marks or other referencing techniques to determine the location of waveguide ends. Femtosecond pulse laser writing enables the formation of point defects within glass substrates that can serve as two dimensional or three dimensional fiducial points. The fiducial points and the laser written waveguides formed within an interconnection substrate may be fabricated using the same process, which may ensure that the fiducial points are created at a known offset from the laser written waveguides. Unlike traditional two dimensional planar fiducial marks, laser written fiducial points can be created within the three dimensional volume of the interconnection substrate, thereby enabling some unique characteristics. For example, fiducial points or reference locations may be embedded into interconnection substrates described herein as points (e.g., voids, bubbles, and the like), lines, or planes. The fiducial points may form point arrays or lines in three dimensional space to create reference sights that ensure that the interconnection substrate is oriented properly relative to one or more vision system cameras. Additionally, a series of fiducial points, having a size ranging from large to small, can be used to progressively guide a vision system to the neighborhood of a laser written waveguide that might be otherwise invisible.

FIG. 7B schematically illustrates an example glass substrate 730 whereby a laser source 737 pulses a femtosecond laser beam into the glass substrate 730 to form fiducial points forming arrays of lines, such as example vertically stacked array of lines 735A and horizontally stacked array of lines 735B. It should be understood that embodiments are not limited to the arrangement of fiducial point lines depicted in FIG. 7B.

In another approach, rather than detecting waveguide ends after attachment of waveguide substrates to the interconnection substrate, waveguide end locations may be determined prior to the attachment of the waveguide substrate(s) to the interconnection substrate. Referring to FIG. 8, an optical fiber probe 812 having a core 813 (e.g., mounted on a precision XYZ stage (not shown)) scans across an end face 844 of an external waveguide substrate 840 having a waveguide 842 (as graphically illustrated by arrows A and B) to generate data (e.g., first data) corresponding to a location of the end of the first waveguide at the end face of the first waveguide substrate. In the illustrated embodiment, the waveguide 842 is disposed between an underclad layer 843 and an overclad layer 845, and the underclad layer 843 is supported by a substrate layer 841. It should be understood that other configurations for the external waveguide substrate 840 and the optical probe 820 are possible. The same optical fiber probe 812 used to scan the end face 844 is also used to scan a waveguide substrate surface 846 (via, for example, detection of optical interference/back-reflections when in close proximity to waveguide substrate) to generate data (e.g., second data) corresponding to a location of the first waveguide with respect to the surface of the first waveguide substrate.

Referring now to FIG. 9, after attachment of the external waveguide substrate 840 to an interconnection substrate 930, previously recorded measurement data obtained from the scanning of the optical fiber probe 812 is used along with in-situ substrate external surface measurements using a scanning device 970 (e.g., a vision system or scanning laser confocal profilometer), to determine waveguide locations. In-plane waveguide locations may also be determined via direct imaging of waveguides or observation of fiducial marks or points, as described above. After external waveguide attachment, a laser written waveguide 936 may be formed from a pre-written waveguide 938 or from a first end face 932 to a second end face 934 at the location of the end of the waveguide 942 of the external waveguide substrate 840.

In a second technique, the locations of waveguide ends of external waveguide substrates are determined during the laser written waveguide formation process. In the techniques described above with respect to FIGS. 1A-9, the ends of the external waveguides are determined prior to forming the laser written waveguides. However, it may be preferable to determine the external or internal waveguide end locations as part of the process of creating a laser written waveguide within the interconnection substrate.

Several different example approaches to this technique are described in detail below. Such example approaches include vision system measurements of laser written waveguide ends, active optical coupling measurements (e.g., power peaking as laser written waveguide ends approach), and successive waveguide write processes that converge to alignment.

In the first approach, techniques described above to determine the location of the external waveguide end prior to external waveguide substrate attachment to the interconnection substrate may also be employed after attachment and during the laser written waveguide formation process. The techniques may be employed either simultaneously while the laser written waveguides are formed or in a repeating sequence wherein a portion of a laser written waveguide is formed, and the end of the laser written waveguide is detected until the laser written waveguide is fully formed within the interconnection substrate. These techniques described above that may be employed include, but are not limited to, optical microscopy and digital imaging of the waveguide end location during the laser writing process, increasing the waveguide core/cladding contrast using Nomarski Differential Interference Contrast imaging, determination of the Z depth of the waveguide end using approaches described previously for existing waveguides (e.g., focus stacking, confocal microscopy, and the like), and determination of the Z depth and exact waveguide location using multiple waveguide images from different angles (e.g., optical tomography).

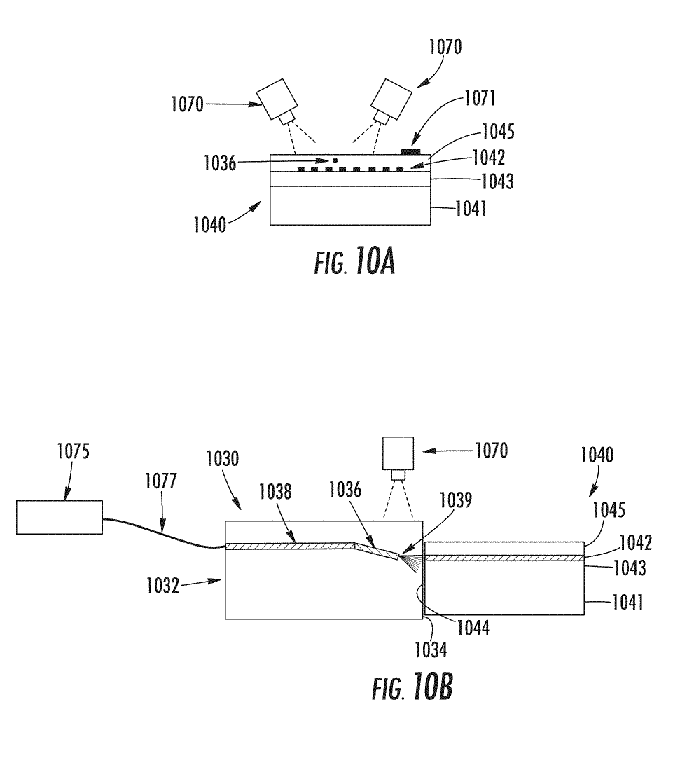

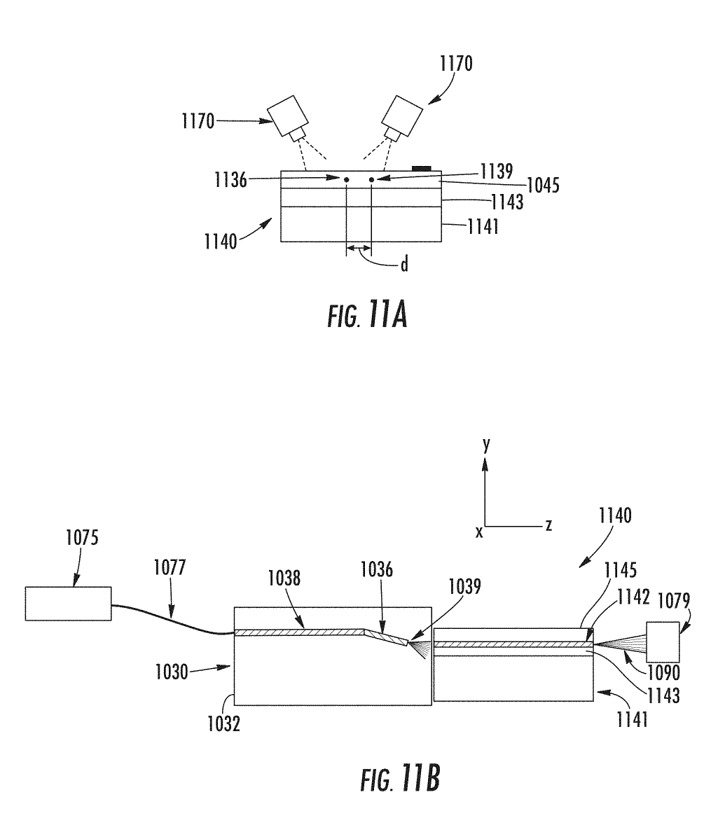

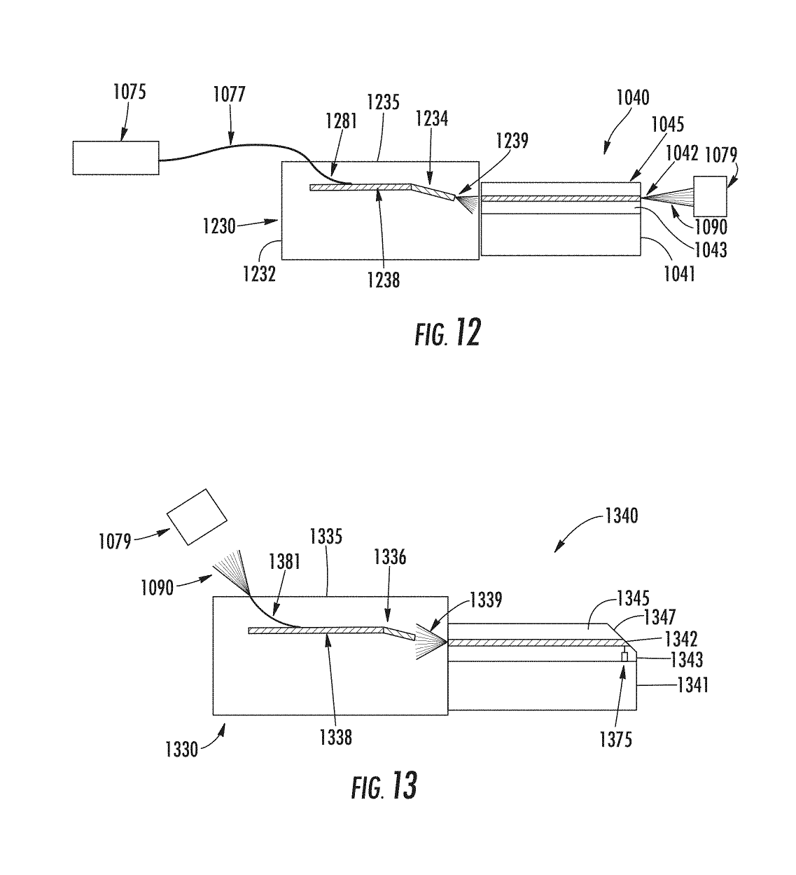

FIG. 10A schematically depicts an example process of forming a laser written waveguide 1036 in an example interconnection substrate 1030. Particularly, FIG. 10A schematically depicts an end view of an example external waveguide substrate 1040 attached to a second end face 1034 of the interconnection substrate 1030. The external waveguide substrate 1040 (i.e., a first waveguide substrate or a first waveguide substrate) includes an array of waveguides 1042 disposed between an underclad layer 1043 and an overclad layer 1045 supported by a substrate 1041. An array of laser written waveguides 1036 are formed within the interconnection substrate 1030 such that individual laser written waveguides 1036 are optically coupled to an individual waveguide 1042. The position of the end of the laser written waveguide 1036 is detected by two or more imaging devices 1070 as it is formed within the interconnection substrate 1030. The two or more imaging devices create multiple images of the laser written waveguide 1036 from different angles. From these multiple images the location of portions of the laser written waveguide 1036 may be determined in three dimensional space to ensure that the laser written waveguide 1036 terminates at the desired waveguide 1042 of the external waveguide substrate 1040.

Further, techniques described above for increasing the visibility of a waveguide as the laser written waveguide is being formed may also be utilized. These techniques include, but are not limited to, guiding light through the laser written waveguide by externally coupled light or laser activation to highlight core location, using an alternative waveguide excitation wavelength, modifying the interconnection substrate composition so that fluorescence occurs near laser written waveguide end, and modifying the glass composition and/or waveguide laser writing process so that light scattering is enhanced along the waveguide path or at the waveguide end, possibly under alternative wavelength illumination.

FIG. 10B schematically illustrates an example of using a light scattering structure 1039 at an end of the laser written waveguide 1036 as it is formed within an interconnection substrate 1030. Although the laser written waveguide 1036 depicted in FIG. 10B is shown as being optical coupled to a pre-written waveguide 1038, it should be understood that the laser written waveguide 1036 may also fully extend between a first end face 1032 and a second end face 1034. Any of the light scattering features described above may be utilized, such as inclusion of defects or voids at the end of the laser written waveguide, or rough walls that scatter light. The light scattering structures written on the end of the waveguide can be repeatedly measured, then overwritten with short waveguide sections that extend toward the target waveguide location, where each short waveguide section is also created with a light scattering structure at its tip. This process can be repeated multiple times to gradually form a waveguide that is aligned to the target waveguide locations.

To enhance detection of the end of the laser written waveguide 1036, a light guide (e.g., an optical fiber) is optically coupled to the pre-written waveguide 1038 at the first end face 1032 (or to the laser written waveguide 1036 at the first end face 1032) and also optically coupled to an light source 1075, such as a laser. Light from the light source 1075 propagates within the pre-written waveguide 1038 and into the laser written waveguide 1036, where it is then scattered by the light scattering structure 1039. The one or more imaging devices 1070 may more readily detect the end of the laser written waveguide 1036 due to the scattered light. After the laser written waveguide 1036 is formed and reaches the second end face 1034 of the interconnection substrate, the laser source utilized to form the laser written waveguide 1036 may be operated to remove the light scattering structure 1039 so that optical signals may be passed between the laser written waveguide 1036 and the waveguide 1042 of the external waveguide substrate 1040. It is noted that one or more surface fiducials 1071 may be disposed on surface of the interconnection substrate 1030 and/or the external waveguide substrate 1140.

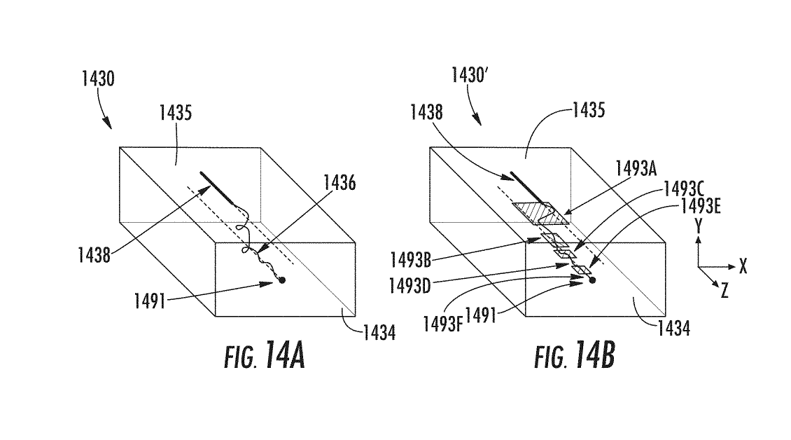

Referring now to FIG. 11A, which provides an end on view of waveguides in a substrate, fiducial points 1139 as described above may be fabricated at known offsets from the laser written waveguide 1136, and may be formed during the formation of the laser written waveguide 1136. The fiducial points 1139 may be fabricated in a manner such that they are more readily visible to one or more imaging device 1170 than the laser written waveguide 1136. FIG. 11A schematically depicts an external waveguide substrate 1140 comprising a substrate layer 1141, an underclad layer 1143 and an overclad layer 1145. The external waveguide substrate 1140 is coupled to the interconnection substrate 1130 through which the laser written waveguide 1136 is formed. One or more surface fiducials marks 1171 may be provided on a surface of the interconnection substrate 1130 and/or the external waveguide substrate 1140 to provide additional reference(s) for the image system to locate the end of the laser written waveguide 136.

Fiducial points 1139 may be created periodically as the laser written waveguide 1136 is formed, at an offset distance d from the laser written waveguide 1136. Since periodic, adjacent fiducial points 1139 are created a fixed distance from each other, they may be used by a vision system as a built-in distance gauge. An image processing system can use this fiducial point spacing information to then estimate the location of the laser written waveguide end.

Fiducial points created during the laser writing process can also be correlated to fiducial points or marks 1171 created during previous laser writing or locating processes. Using this location information the laser written waveguide can be routed to align with the previously located waveguide end.

While FIG. 11A shows a single fiducial point 1139 adjacent to the laser written waveguide 1136, two or more fiducial points 1139 may be written. For example, fiducial points 1139 may be written to the left and right of the laser written waveguide 1136 so that an imaginary line may be connected between the points, where the midpoint of the imaginary line marks the exact location of the laser written waveguide 1136 end. This approach may also be extended in the vertical direction (i.e. the z-axis), where fiducial points are written directly above and below the laser written waveguide as an aid for locating the laser written waveguide end.

By reducing the spacing between successive fiducial points 1139, a single fiducial line may be created in the waveguide to aid in locating the laser written waveguide end location. As described above with respect to FIG. 7B, two or more parallel fiducial lines e.g., a first line and a second line) may be created an offset distance d on opposite sides of the laser written waveguide 1136, so that by connecting the end points of each fiducial line by an imaginary reference line, the exact location of the laser written waveguide 1136 end may be determined even if the laser written waveguide 1136 end is not visible.

Optical coupling measurements may also be utilized to locate waveguide ends in a power peaking/hill climb alignment technique as described below.

FIG. 11B schematically depicts an example power peaking approach implemented using an interconnection substrate 1030 attached to an external waveguide substrate 1140 (e.g., by an adhesive). A pre-written waveguide 1038 is formed in the example interconnection substrate 1030. A laser written waveguide 1036 is initiated at an internal end of the pre-written waveguide 1038. It should be understood that a pre-written waveguide 1038 may not be provided in other embodiments. A light source 1075 directs light through a light guide (e.g., an optical fiber) and into the pre-written waveguide 1038 of the interconnection substrate 1030. This light propagates in the pre-written waveguide and then couples into the laser written waveguide 1036 that is actively being written. Light scatters from the end of this second waveguide (e.g., by a light scattering structure, as described above), and a portion of the scattered light couples into the adjacent waveguide 1142 of the external waveguide substrate 1140. A detector 1079 is positioned at a far end of the external waveguide substrate 1140 and is operable to detect an optical power of light 1090 emitted from the waveguide 1142 of the external waveguide substrate 1140. Alternatively the detector 1079 may be mounted on the external waveguide substrate 1140. Accordingly, the detector 1079 provides a relative measurement of the amount of optical power coupled between the end of the laser written waveguide 1036 and the adjacent waveguide 1142 end of the external waveguide substrate 1140.

The power peaking approach may be employed in a situation where initially a large axial offset exists between the two optical fibers. In this case, as the fibers are brought closer together they can be simultaneously laterally offset relative to one another. While the power peaking/hill climb algorithm will not necessarily identify the optimal lateral offset for maximum coupling (because coupled power always increases as the optical fiber approach one another), if the lateral offsets are large enough a coupled power peak will occur that provides guidance on the route towards maximum coupled power. Since coupled power becomes highly sensitive to lateral misalignments at small axial separations, the approach will eventually converge to the lateral offset associated with maximum coupled power.

As the laser written waveguide is formed, its path can be made to gradually turn in the X and Y directions so that a lateral offset is introduced between the laser written waveguide 1036 end and the adjacent external waveguide substrate 1140 waveguide 1142 end. Since the optical coupling between waveguide ends is a function of lateral offsets, the variation in measured power at the detector 1079 over the course of the laser written waveguide 1036 turn provides information on the optimal lateral offset condition in X and Y where coupled power is maximized. The algorithm used to control the movement of the laser can alternate between left-right bends (i.e., along the x-axis) and up-down bends (i.e., along the y-axis) to explore various lateral offset conditions. The laser written waveguide 1036 is written such that it follows a path toward highest coupled power while maintaining minimum bend radius requirements to minimize unwanted bending losses.

The approach is attractive because it does not require information on the absolute location of either waveguide end prior to initiation of the alignment process.

It should be noted that in FIG. 11B, as well as in the following figures, the subsequent laser written waveguide is shown between a pre-written waveguide end and a waveguide substrate waveguide end. The alignment techniques herein are equally applicable to configurations where a laser written waveguide is created across the interconnection substrate between two waveguide ends positioned on different facets of the interconnection substrate, as noted above.

In example illustrated by FIG. 11B, light is coupled into the pre-written waveguide 1038 through a first end face 1032 on one side of the interconnection substrate 1030. Referring to FIG. 12, in some situations, it may desirable to form the pre-written waveguide 1238 completely within the interconnection substrate 1230, so that subsequent laser written waveguides (e.g., laser written waveguide 1236) can be formed on both ends of the pre-written waveguide 1238 for interconnections to waveguide substrates joined directly to first and second end faces 1232, 1234 of the interconnection substrate 1230. A problem with this configuration is that there is no convenient way to efficiently couple light directly into the pre-written waveguide 1238 because it does not terminate at an end face.

In situations where a waveguide substrate has not yet been bonded onto an end face of the interconnection substrate 1230 (e.g., first end face 1232) an external focusing lens (e.g., a microscope objective) could be used to focus light down to a focal region located within the interconnection substrate. By appropriate relative translation, it is possible to make this focal spot line up with the pre-written waveguide 1238 end within the interconnection substrate 1230.

In situations where a waveguide substrate has already been attached to the end face of the interconnection substrate 1230, or in situations where the position of the interconnection substrate 1230 in a larger system prevents clear access to the end face, a surface combiner waveguide 1281 within the interconnection substrate 1230 is used as a means for coupling light into the pre-written waveguide. The example surface combiner waveguide 1281 is configured as a laser written waveguide that is initiated at a surface 1235 of the interconnection substrate 1230 and is integrated with the pre-written waveguide 1238 (i.e., optically coupled to the pre-written waveguide 1238). Accordingly, one end of the surface combiner waveguide 1281 forms a low-angle Y-junction with the pre-written waveguide 1238, and the other end extends to the surface 1235 of the interconnection substrate 1230. By coupling light into the surface combiner waveguide 1281, either using a light guide 1077 as shown in FIG. 12, or by using coupling lenses, light can be directed into the pre-written waveguide 1238, and then into the subsequently formed laser written waveguide 1236. Because the surface combiner waveguide 1281 is oriented at an angle relative to the pre-written waveguide 1238, light may be coupled into the surface combiner waveguide 1281 using broad area illumination that poorly couples to the pre-written waveguide 1238 due to a large angular misalignment. The power peaking approach described above with respect to FIG. 1B may be utilized by measuring light 1090 exiting the waveguide 1042 so that the laser written waveguide 1236 follows a path toward highest coupled power.

In a later step, an additional laser written waveguide (not shown) can be formed to optically link the opposite end of the pre-written waveguide 1238 (e.g., the left end of the pre-written waveguide 1238 in FIG. 12) to a waveguide end of another substrate waveguide (not shown) coupled to the first end face 1232. In this case, light would be directed left to right as depicted in FIG. 12 through the interconnection substrate waveguides, so that light would not efficiently couple out of the pre-written waveguide 1238 via the surface combiner waveguide 1281. In some embodiments, the surface combiner waveguide 1281 may be disabled after the laser written waveguides are fully formed by writing a high index waveguide through the pre-written waveguide 1238.

FIG. 13 refers to an example where light propagates from a waveguide 1342 of an attached waveguide substrate 1340 into an interconnection substrate 1330 (i.e., right-to-left in FIG. 13). The example waveguide substrate 1340 comprises a substrate layer 1341, an underclad layer 1343, one or more waveguides 1342, and an overclad layer 1345. The example waveguide substrate 1340 further includes an active optical component 1375 configured as a laser diode operable to emit light. An angled facet 1347 provides a total internal reflection surface that turns light emitted from the active optical component 1375 into the waveguide 1342.

The formation of the laser written waveguide 1336 of the interconnection substrate 1330 is initiated at an end of the pre-written waveguide 1338. A surface tap waveguide 1381 is formed (e.g., by a laser writing process) from a surface 1335 of the interconnection substrate 1330 to the pre-written waveguide 1338 in a similar manner as the surface combiner waveguide 1281 illustrated in FIG. 12. Light 1339 exiting the waveguide 1342 is scattered within the interconnection substrate 1330. A portion of the light 1339 exiting the waveguide 1342 enters the laser written waveguide 1336, which enters the pre-written waveguide 1338, and then enters the surface tap waveguide 1381. Optical power of light 1090 exiting the surface tap waveguide 1381 is detected by a detector 1079 as the laser written waveguide 1336 is formed. The path of the of the laser written waveguide 1336 may be such that the power peaking method of optical coupling as described above with respect to FIG. 11B is employed.

After the laser written waveguide 1336 is completed, the surface tap waveguide 1381 may be disabled by forming a higher index waveguide through the path of the pre-written waveguide 1338. This higher index waveguide provides strong guiding that limits the amount of power that can couple out of the surface tap waveguide 1381. Alternatively, the surface tap waveguide 1381 may be implemented using a directional coupler. Initially, the length of the directional coupler may be selected to maximize power coupled out of the surface tap waveguide 1381. After completing the laser written waveguide link, the length of the directional coupler could be extended (i.e., doubled), so that light is completely coupled back into the pre-written waveguide 1338. Alternatively a wavelength can be used for alignment illumination that is considerably different than the normal wavelength of operation for the waveguide. A directional coupler used as a tap can be designed with a length that enables strong coupling to the tap waveguide at the alignment illumination wavelength, and poor coupling to the tap waveguide at the operational wavelength.

As described above with respect to FIGS. 11B, 12, and 13, the path of the laser written waveguide may be manipulated to monitor the optical power of light coupled out of the assembly in a power peaking process. The laser written waveguide formed between the pre-written waveguide and the waveguide substrate waveguide in FIGS. 11B, 12, and 13 may be created using a variety of different path options, including, but not limited to, a spiral path 1436 that gradually reduces its search radius as the coupling gap is reduced as shown in FIG. 14A, and a serpentine path defined by laser written waveguide portions 1493A-1493F that sweeps left-right, then up-down in alternation during a power peak search as shown in FIG. 14B. It is noted that, in all cases, the laser written waveguide path should be created with gradual curves with a radius of curvature that is above a minimum amount required for low-loss propagation of optical signals propagating therein.

FIG. 14A illustrates an interconnection substrate 1430 having a surface 1435, an end face 1434, a prewritten waveguide located proximate the surface 1435, and a target location 1491 at the end face 1434 for the laser written waveguide 1436. The target location 1491 is the location on the end face 1434 that will provide the highest optical coupling (i.e., the maximum optical power) between the laser written waveguide 1436 and a waveguide of an attached external waveguide substrate (not shown in FIGS. 14A and 14B for ease of illustration).

As shown in FIG. 14A, the laser written waveguide 1436 is initiated at an end of the pre-written waveguide 1438 (or an edge of the interconnection substrate 1430 in embodiments that do not utilize a pre-written waveguide) near the surface 1435 and follows a spiral path in three-dimensional space into a bulk of the interconnection substrate 1430. The spiral shape of the path allows the position of the laser written waveguide 1436 to vary along the x-axis and the y-axis as it varies in depth (the z-axis) so that laser written waveguide may converge on the target location 1491 by utilizing a power peaking algorithm.

In the interconnection substrate 1430′ illustrated by FIG. 14B, a position of a first portion 1493A of the laser written waveguide varies to provide lateral offsets in a first plane (e.g., a first plane along the x-axis providing a horizontal offset). As the first portion 1493A of the laser written waveguide is formed, optical power exiting either the interconnection substrate 1340′ or an external waveguide is measured and evaluated according to a power peaking algorithm such that an optimum lateral offset in the first plane is identified. After writing the first portion 1493A of the laser written waveguide, a position of a second portion 1493B of the laser written waveguide varies starting from an optimal first position in the first plane that was previously determined to provide lateral offsets in a second plane (e.g., a second plane along the y-axis providing a vertical offset). As the second portion 1493B of the laser written waveguide is formed, optical power is measured and evaluated according to a power peaking algorithm such that an optimum lateral offset in the second plane is identified to determine an optimal second portion. Any number of subsequent iterations may be performed in the first and second planes to create additional portions of the laser written waveguide to obtain convergence of the laser written waveguide at the target location 1491. FIG. 14B depicts a laser written waveguide comprising a third portion 1493C, a fourth portion 1493D, a fifth portion 1493E, and a sixth portion 1493F alternatively formed within the first and second planes.

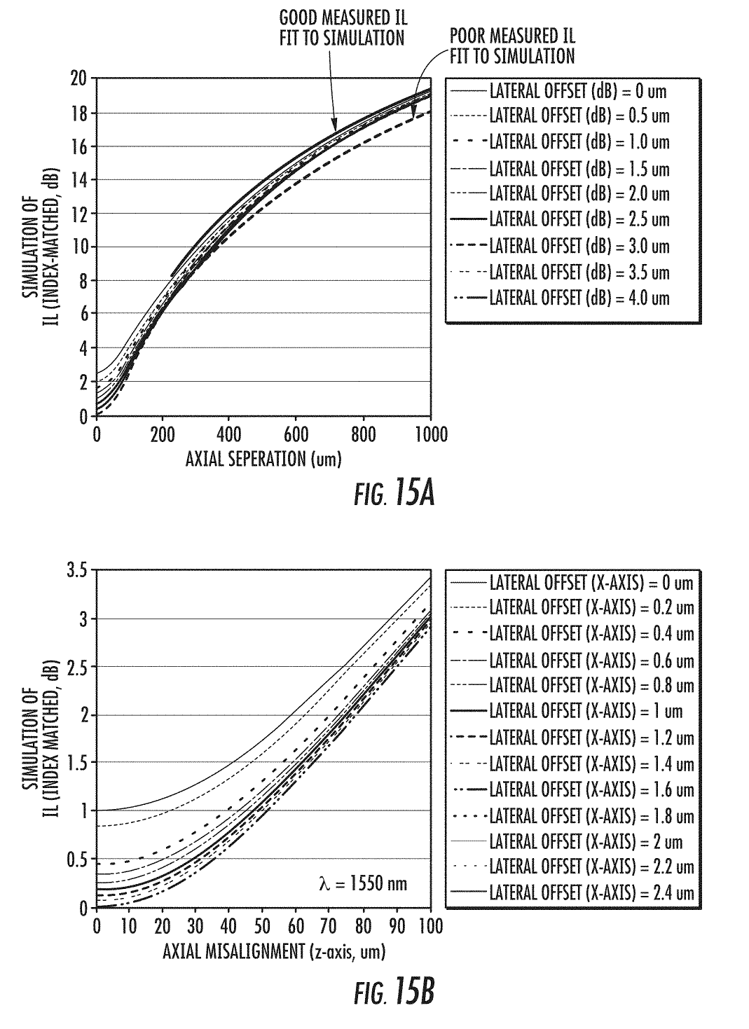

An alternative to the power peaking hill climb approach described above is a multivariable curve fit approach that is based on knowledge of how coupled power between misaligned waveguides depends on the lateral, axial, and angular offsets associated with the coupled waveguide pair. FIG. 15A provides a plot of simulation data for coupled SMF-28 optical fibers under axial and lateral misalignment. The plots shown in FIGS. 15A and 15B were derived from an optical coupling model based on the paper W. B. Joyce and B. C. DeLoach, “Alignment of Gaussian beams,” Appl. Opt. 23, 4187-4196 (1984). The model takes into consideration the axial, lateral, and angular misalignments that may exist between a launching source waveguide with a given width w1 and a receiving waveguide with a given width w2 (assuming same width in x and y directions, which is not a requirement). Using the model, a family of curves may be generated shown by fixing a given lateral misalignment value, and then sweeping over a range of axial values, to generate a single curve on the plot. The entire plot is generated by repeating the calculations for other lateral misalignment conditions.

The plot shows how different insertion loss (“IL”) curves are created as a function of waveguide core lateral offset. The solid and dotted curves represent measurement data taken over the same single axial sweep, where the only difference between the curves is that they have been shifted vertically by different amounts in an attempt to find the best match with one of the simulated IL curves for different lateral misalignments. Actual measured data may be compared to the family of curves. A curve fit process shows that the measured data is a better fit to the 4.0 μm lateral misalignment condition than the 0 μm lateral misalignment case. Based on this curve fit process, the trajectory of the laser written waveguide can be adjusted by 4.0 μm in an attempt to minimize coupling losses and perfectly align with the target waveguide end.

The multivariable curve fit approach includes the following steps, which can be executed repeatedly as the laser written waveguide alignment path is formed. First, the insertion loss is measured while creating laser written waveguide along a three dimensional path that approaches the target waveguide end. A best fit of measured IL data is calculated and compared to a predicted IL curve that is based on known XYZ stage displacements and waveguide tilts along the three dimensional path. Using the best fit of measured IL data to simulated data. XYZ coordinates of a target location of the laser written waveguide end is calculated. The laser written waveguide is continued to be formed toward the XYZ coordinates of the target location. The curve fit process may be repeated process multiple times (or continuously) during laser written waveguide formation process.

In the example depicted by FIG. 15A, it is not clear if the waveguide lateral misalignment is oriented in the x-axis or y-axis direction, or in some other direction. In practice, as the laser written waveguide alignment path is formed (generally moving parallel to the z-axis), it would include minor lateral deviations in both the x-axis and v-axis directions. The measured IL response to these x-axis and y-axis lateral deviations would serve as a unique IL signature. This IL signature may be compared to the set of IL curves generated. Instead of the effective one dimensional lateral sweep inherent in the plot in FIG. 15A, a larger family of IL curves may be created by simulating the influence of moving the target waveguide end over the full range of possible x-axis and y-axis lateral misalignment conditions. Each IL curve is generated based on the exact XYZ path followed by the laser written waveguide. Then a comparison of the signature IL curve may be made to each IL curve associated with each XY lateral misalignment condition, and the XY lateral misalignment condition associated with the best fit would be selected as the new estimate for the waveguide end locations.

A similar distinction in IL curves as a function of lateral offset exists at close z-axis separation distances. The largest differences in IL response occur when axial separations are smallest (i.e., the end of the laser written waveguide is close the end face and the target location). This means that as the multivariable curve fit approach progresses, successively more and more precise estimates of target waveguide end location can be made. FIG. 15B illustrates simulated IL curves as a function of lateral offset for axial separations (i.e., z-axis separations) of 0 to 100 μm.

The IL curve fitting approach may be beneficial because it is insensitive to IL offsets that are likely to occur when coupling light from a source through the glass interconnection block and to a detector. At each step it provides an estimate of the magnitude of the lateral misalignment that should be corrected to achieve low-loss coupling at each point along the alignment path. However, any existing waveguide end or laser written waveguide non-uniformities (i.e., variations in index profile from expected values) may alter IL curve shape and introduce errors in required lateral offset. In principle, these errors can be reduced through comprehensive characterization of waveguide dimensions and far-field properties. Since these waveguide properties are not expected to change significantly over the course of the alignment process, they could also be rolled into the multivariable curve fitting process as additional variables to consider. Further, IL curves may be slightly altered by errors in z-axis separation distance estimation. Optical measurement techniques should provide accurate estimates of waveguide end axial separation, to <15-25 μm, so the IL errors associated with incorrect axial separation estimates should be small. Ultimately this variation could also be included in the multivariable curve fitting process.

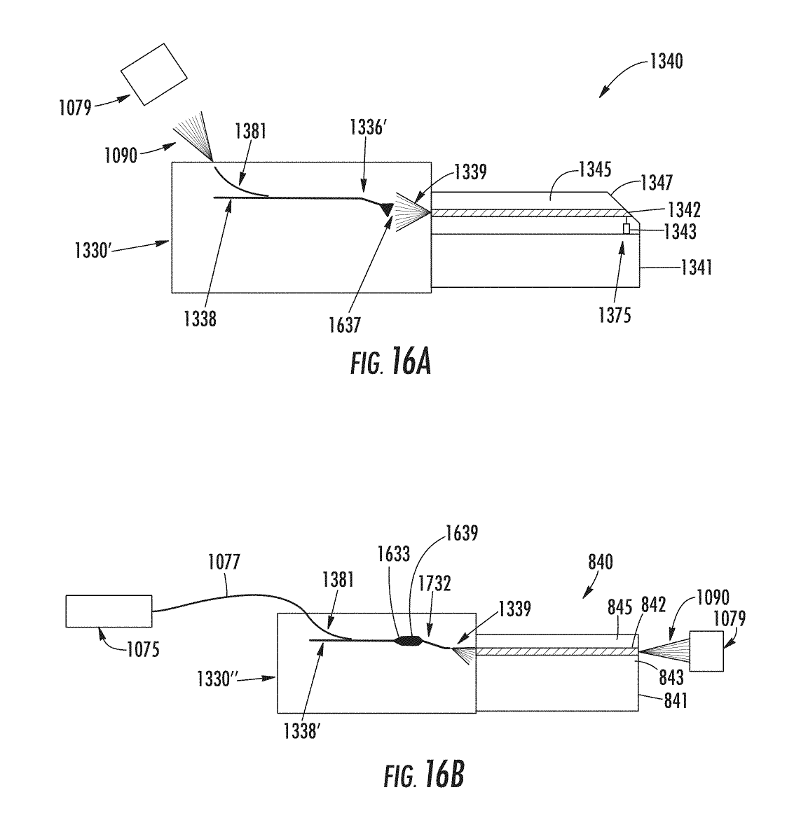

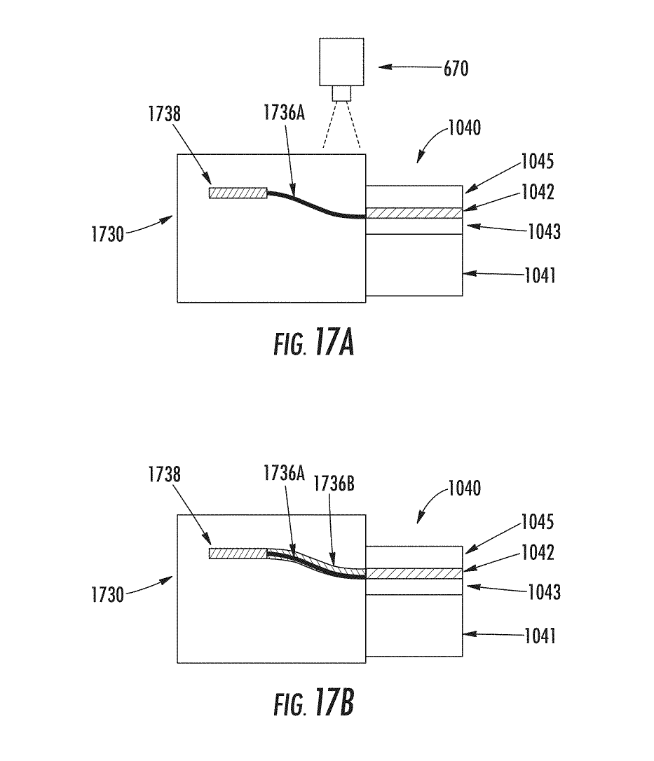

To minimize optical coupling losses at locations where the laser written waveguides meet another waveguide, in some embodiments the index profile or diameter of the laser written waveguides can be modified as the laser written waveguides move toward the target location of the laser written waveguide end. FIG. 16A schematically illustrates an interconnection substrate 1330′ and attached external waveguide substrate 1340 similar to those depicted in FIG. 13. However, the end of the laser written waveguide 1336′ includes a tapered section 1337 that expands the laser written waveguide 1336′ core diameter in the coupling region that may minimize lateral misalignment losses. Additionally, larger diameter waveguide cores also minimize beam divergence moving away from pre-written waveguide 1338 existing waveguide, making it easier to perform a power peaking analysis at greater axial separations with minimal lateral offset of the laser written waveguide 1336′.

Referring to FIG. 16B, waveguide tapers may be used to expand waveguide diameters at coupling interfaces internal to the interconnection substrate 1330″. An end of the pre-written waveguide 1338′ includes a first tapered section 1633 having an increasing diameter in a direction toward the laser written waveguide 1336″. An end of the laser written waveguide 1336″ includes a second tapered section 1639 having an increasing diameter in a direction toward the pre-written waveguide 1338′. The first tapered section 1633 is optically coupled to the second tapered section 1639. The first and second tapered sections 1633, 1639 provide waveguide core expansion at the coupling interface between the pre-written waveguide 1338′ and the laser written waveguide 1336″.

Pulsed lasers, such as femtosecond pulsed lasers, can be used to gradually transform optical waveguide properties over successive laser writing passes. For example, an initial waveguide with a low index of refraction or a small diameter may initially be created, and then a repeat writing process over the same initial waveguide path may be performed to increase the index of refraction and/or the waveguide diameter of the initial waveguide. The effective diameter of a laser written waveguide can also be reduced by laser writing a waveguide with a higher index of refraction but a smaller core diameter over a path that was previously created with a low index of refraction and a larger core diameter.

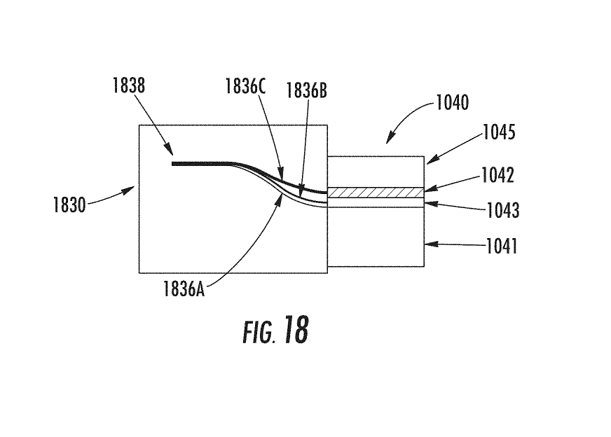

Because light prefers to follow high index of refraction waveguide paths over low index of refraction waveguide paths, multiple laser waveguide writing operations written with successively higher indices of refraction can also gradually or dramatically alter the waveguide path. FIG. 17A schematically illustrates an example interconnection substrate 1730 attached to an external waveguide substrate 1040. The interconnection substrate 1730 includes a pre-written waveguide 1738, and a laser written waveguide 1736A extending from the pre-written waveguide 1738 that is slightly misaligned relative to a target end of the waveguide 1042 of the external waveguide substrate 1040. A vision system inspection using a imaging device 670 or other detector device may be used to detect the misalignment magnitude and direction. Referring to FIG. 17B, a subsequent laser written waveguide 1736B, with a higher index of refraction and larger core diameter, is written to correct the misalignment error and provide a low coupling loss connection to the target waveguide end. Because light prefers to follow high index of refraction waveguide paths, the light will propagate through the subsequent laser written waveguide 1736B rather than the initial laser written waveguide 1736A.

Further, using a power peaking hill climb algorithm or the multivariable curve fit approaches described above, a laser written waveguide can be written with an initially low index of refraction through a interconnection substrate. Based on IL measurements made along the path and/or after the laser written waveguide reaches the target location, a decision may be made to reattempt the laser written waveguide alignment by writing one or more additional laser written waveguides at successively higher indices of refraction along a different paths. Light does not couple into the previously written waveguides because their indices of refraction are all low compared to last waveguide written.

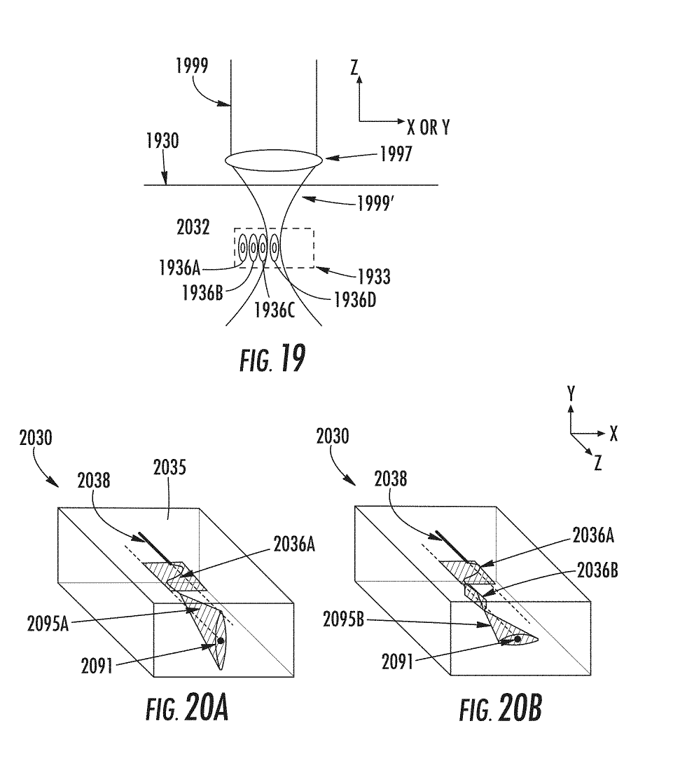

As stated above, multiple laser writing passes over a waveguide path can be used to alter other characteristics of the waveguide. For example, a laser written waveguide that was initially created with a rough sidewall surface for enhanced visibility via light scattering can be written over in a second laser writing pass that alters the waveguide sidewall roughness to reduce scattering and therefore reduce propagation IL through the waveguide. FIG. 18 schematically illustrates an interconnection substrate 1830 attached to an external waveguide substrate 1040 having a waveguide 1042. A first laser written waveguide 1836A is written from an end of the pre-existing waveguide 1838 to an end face 1834. A power peaking hill climb algorithm or a multivariable curve fit approach is used to determine a lateral offset of the end of the first laser written waveguide 1836A and the end of the waveguide 1042 (during and/or after completion of the first laser written waveguide 1836A). A decision is made to form a second laser written waveguide 1836B that is closer to the target location of the end of the waveguide 1042 and has a higher index of refraction than the first laser written waveguide. Finally, a third laser written waveguide 1836C is formed having a higher index of refraction than the second laser written waveguide 1836B that reaches the target location and the end of the waveguide 1042.

As another iteration, multiple waveguides having different aspect ratios going from a high aspect ratio to a round or square shape may be written in successive writing processes. Creation of square optical waveguides using femtosecond pulse laser writing techniques involves multiple write passes due to the high aspect ratio shape of the region affected by the focused laser. This characteristic enables the creation of waveguides that initially have a high aspect ratio, but which can be converted to a more squarely shaped waveguide by multiple write steps. As an example, FIG. 19 schematically illustrates a focused laser 1999′ forming multiple laser written waveguides using multiple passes of a high aspect ratio focus region in a substrate 1930. A rectangular desired waveguide section 1933 is indicated by the dashed lines. One or more lenses 1997 focus the laser 1999 into the focused laser 1999′ having a focal point within the substrate 1930. Four laser written waveguides 1936A-1936D having a high aspect ratio more narrow in the z-axis direction are illustrated within the rectangular desired waveguide section 1933.

Some embodiments take advantage of writing a high aspect ratio waveguide initially to aid in the alignment of laser written waveguides, followed by multiple laser write processes to create more square waveguides.

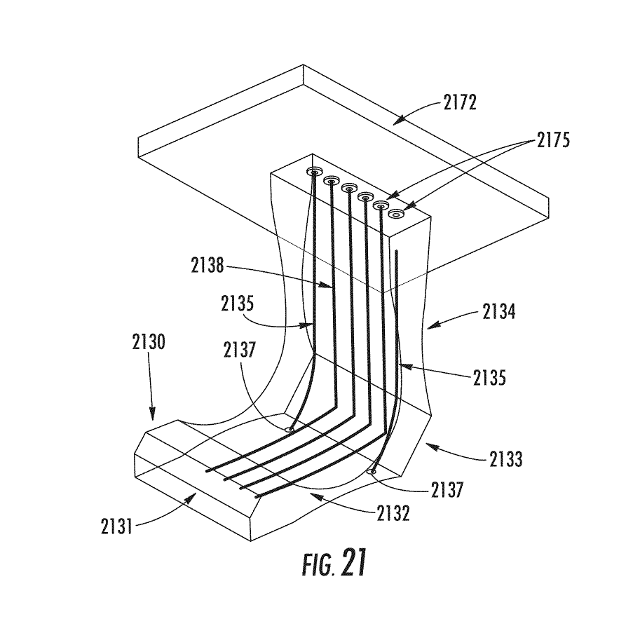

FIGS. 20A and 20B schematically illustrate a laser waveguide alignment process where high aspect ratio waveguide are first written so that the waveguides are narrow in a first axis direction and then a second axis direction. Referring first to FIG. 20A, an example interconnection substrate 2030 includes a pre-written waveguide 2038 proximate a surface 2035. A first portion 2036A of a laser written waveguide is initiated at an end of the pre-written waveguide 2038. The first portion 2036A of the laser written waveguide is written such that it has a first high aspect ratio that is narrow in a first plane, such as a plane in the y-axis direction. This portion may be formed by writing from the side of the interconnection substrate 2030, so that the focus region extends significantly parallel to the x-axis direction. Because the waveguide is narrow in the y-axis direction, light coupled out of the waveguide end within the interconnection substrate 2030 will tend to diffract more in the vertical (v-axis) direction than the horizontal (x-axis) direction in a diffracted beam 2095A. In an attempt to determine the x-axis lateral offset position where optical coupled power is maximized, the first portion 2036A of the laser written waveguide is swept along the x-axis in the first plane while coupled light is monitored at the target location 2091 corresponding to an end of a waveguide of an attached waveguide substrate (not shown in FIGS. 20A and 20B). The large asymmetry of the diffracted beam 20 makes the optical coupling to the target waveguide location highly sensitive to x-axis lateral misalignment, and less sensitive to y-axis lateral misalignment. This decoupling of x-axis and y-axis coupling loss contributions, combined with the more relatively narrow extent of the diffracted beam in the x-axis direction, allows the estimation of x-axis optimal lateral misalignment to be more accurate.

Referring to FIG. 20B, after the optimal x-axis lateral offset position is determined, a second portion 2036B of the laser written waveguide is then written from the surface 2035 of the interconnection substrate 2030 to form a waveguide having a second high aspect ratio that is narrow in a second plane, such as a plane in the x-axis direction. This causes light to diffract more in the horizontal (x-axis) direction in a diffracted beam 2095B. The alignment process described above with respect to FIG. 20A is repeated, this time with a vertical sweep (i.e., along the y-axis) to determine the optimal y-axis lateral offset position. The back and forth process of alternating between high vertical diffraction and high horizontal diffraction beams may be repeated until the laser written waveguide path converges on the target location 2091.

In embodiments, it may be easier to create the orthogonally oriented high aspect ratio waveguide cores by tilting the vertical beam within the interconnection substrate as shown in FIG. 20B alternately at a +45° angle (toward the +x-axis) and −45° angle (toward the −x-axis). Index matching oil may be utilized to prevent reflections at the air/glass interface and to enable laser illumination at a practical angle relative to the interconnection substrate 2030, based on laser beam focusing lens working distance limitations.

If it is difficult to arrange the laser illumination path in the +45°/−45° angle configuration, the high aspect ratio alignment process can still be employed using a single beam written from above the interconnection substrate 2030, where the alignment process described above is only employed vertical axis sweeps (e.g., FIG. 20B). In this case, the alternation would be between a single high aspect ratio waveguide, and a more square waveguide formed using multiple passes as shown in FIG. 19. While this approach may not converge as quickly as the orthogonal high aspect ratio approach described above with respect to FIGS. 20A and 20B, it may still be sufficient for rapid laser written waveguide alignment, since the first pass under high aspect waveguide conditions effectively optimizes for one axis. With this first axis already optimized, the second pass with a more rectangular waveguide effectively provides optimization in the second axis.

After the process of laser written waveguide alignment is complete, the waveguides can be rewritten using multiple passes to create round or square waveguides with the desired index of refraction profile.

It is noted that information obtained on waveguide end locations via vision system measurements as described with respect to FIGS. 1A-9 can be merged with the optical coupling-based alignment approaches as described with respect to FIGS. 10A-20B. A vision system may be utilized to generate a best initial estimate of waveguide locations, such as a coarse alignment to within 5-25 μm. Optical coupling measurements may then be utilized to refine position estimates for existing waveguide and laser written waveguide (e.g., to within 0.5 μm). Laser written waveguides can be laser written toward existing waveguide ends based on information from both techniques. With a small uncertainty in laser written waveguide lateral misalignment after vision system assessment, laser written waveguides created using optical coupling measurements may avoid optically lossy small bend radius turns over mm-scale gaps.

The cross-sectional area of an interconnect substrate taken perpendicular to internal waveguides is generally at least two orders larger than the area dedicated to optical waveguide cores. Therefore, there is room within the interconnection substrate for additional waveguides that may be used solely for alignment of optical waveguides that extend across the interconnection substrate. Similarly, active or passive photonic devices used for coupling light into or out of interconnection substrates often have unused space in the regions immediately around vertical cavity surface emitting lasers (“VCSELs”) and photodetectors to provide bonding area for optical fiber connector bodies and interconnection substrate facets.

The photolithographic process used to create these optical source and detector devices can also be used to create a few additional devices adjacent to the array of devices already dedicated to implementing the optical link. These additional optical sources and detectors can be used to implement a laser written waveguide alignment scheme where additional alignment waveguides are first written between the additional source and detector devices to determine the exact position of photonic chip active or passive devices relative to the mounted interconnection substrate. Once this operation is performed for the outboard alignment waveguides, the position of the remaining optical sources and detectors dedicated to the optical link function can be accurately calculated based on linear interpolation between the alignment sources and/or detectors. Then, laser written waveguides can be formed within the interconnection substrate between source and detector devices or other waveguide interfaces located on the interconnection substrate facets.

FIG. 21 schematically illustrates an example alignment process utilizing additional outboard optical sources 2175 disposed on a substrate 2172. It should be understood that the configuration depicted in FIG. 21 is for illustrative purposes only, and that methods of using additional optical sources for optical alignment may utilized using any configuration. The two outboard optical sources 2175 are not utilized for optical communication but rather for alignment as described above.

A glass optical coupling component 2130 is optically coupled to a plurality of optical sources 2175. The glass optical coupling component 2130 includes a first portion 2134 optically coupled to the plurality of optical sources 2175, an optical turn portion 2133, and a second portion 2131. The second portion 2131 may be optically coupled to one or more additional optical components (not shown) at its edge face.

The glass optical coupling component 2130 includes pre-written optical waveguides 2132 in the second portion 2131 and pre-written waveguides 2138 in the first portion 2134. These pre-written waveguides will guide optical signals in the end application to provide optical communication. The glass optical coupling component 2130 further includes two detector locations 2137 where two photodetector devices may be positioned to detect optical signals during the alignment process. The detector locations 2137 may be located at other locations within the glass optical coupling component 2130, such as at the optical turn portion 2133.

Two alignment waveguides 2135 are optically coupled to the two detector locations 2137. The two alignment waveguides 2135 are written toward its associated optical source 2175. In some embodiments, a majority of the alignment waveguides 2135 are pre-written leaving a gap between end of the pre-written alignment waveguide 2135 and its optical source 2175. The remainder of the alignment waveguide 2135 is laser written as described above. The associated optical source 2175 (e.g., an outboard optical source 2175 as shown in FIG. 21) is activated to couple light into the alignment waveguide 2135, such as while it is being written. The light is detected by a photodetector device positioned at the detector location 2137. Using the power peaking methods described above, the remainder of the alignment waveguide 2135 is written such that optimum optical power is received at the photodetector device. After laser writing each alignment waveguide 2135, XY coordinate information is recorded and, based on this XY coordinate information, an offset of the array of optical sources 2175 with respect to the pre-written waveguides 2138 is determined. The position of the glass optical coupling component 2130 with respect to the substrate 2172 may be adjusted in accordance with the determined offset such that the pre-written waveguides 2138 are aligned with the plurality of optical sources 2175.

In some embodiments, the pre-written waveguides 2138 terminate a short distance away from the edge of the glass optical coupling component 2130 at the plurality of optical sources 2175. After the alignment process described above and using the determined offset information, the remaining portions of the pre-written waveguides 2138 are laser-written toward the respective optical sources 2175. In this manner, the pre-written waveguides are optically coupled to the optical sources 2175.

It should now be understood that embodiments of the present disclosure are directed to optical assemblies and interconnection substrates for coupling waveguides of external waveguide substrates, as well as methods for forming laser written waveguides within an interconnection substrate such that the laser written waveguides are substantially aligned with the respective external waveguides of attached waveguide substrates. Various alignment methodologies are disclosed, such as direct methods of determining waveguide or fiducial locations using vision system techniques prior to or during waveguide formation, use backlighting to determine waveguide end location, of power peaking/hill climbing algorithms to find optical convergence of the waveguide end to a target location, and multivariable curve fit approaches to find optical convergence of the waveguide end to the target location.

Embodiments enable the fabrication of laser written single-mode waveguide optical loss performance at long wavelengths (λ=1310-1550 nm), which may be lower than similar waveguides formed in polymer materials. The exact determination of waveguide end locations enables creation of optical waveguide links within the interconnection substrate that minimize bend losses by using the maximum bend radius possible for a given waveguide end lateral misalignment. Further, waveguide tapers may be formed in laser written waveguides near waveguide ends to minimize sensitivity to lateral misalignment errors. Laser written waveguide formation processes leverage existing precision stage placement techniques (<0.5 um lateral misalignment) developed for fiber array to photonic chip interfaces. The laser writing process enables rapid creation of optical waveguides using high write speeds (>10 mm/sec). Optical inspection techniques for identifying waveguide ends can be incorporated into same XYZ gantry used to support laser written waveguide optics.

Additionally, all components may be fabricated from low-cost glass materials that have precision surfaces (e.g., glass sheet fusion forming or redrawn glass component fabrication). The interconnection substrates used to join photonic components may provide a more robust mechanical joint than low modulus polymer materials, including excellent coefficient of thermal expansion (“CTE”) match to minimize interface strains. Further, glass redraw processes enable fabrication of thin flexible interconnection substrates that sustain CTE-mismatch induced lateral displacements without delamination or breakage.

It will be apparent to those skilled in the art that various modifications and variations can be made without departing from the spirit or scope of the disclosure. Since modifications, combinations, sub-combinations and variations of the disclosed embodiments incorporating the spirit and substance of the disclosure may occur to persons skilled in the art, the disclosure should be construed to include everything within the scope of the appended claims and their equivalents.

1. An optical assembly comprising:
a first waveguide substrate comprising a first waveguide;
a second waveguide substrate comprising a second waveguide;
an interconnection substrate comprising a first end face, a second end face, and a laser written waveguide, wherein:
the first waveguide substrate is coupled to the first end face of the interconnection substrate;
the first waveguide is optically coupled to the laser written waveguide;
the laser written waveguide terminates at the second end face of the interconnection substrate; and
the second waveguide substrate is coupled to the second end face of the interconnection substrate such that the second waveguide is optically coupled to the laser written waveguide at the second end face.

2. The optical assembly of claim 1, wherein:
the interconnection substrate further comprises a pre-written waveguide;
the first waveguide is optically coupled to the pre-written waveguide at the first end face; and
the laser written waveguide is optically coupled to an end of the pre-written waveguide.

3. The optical assembly of claim 2, wherein:
the end of the pre-written waveguide comprises a first tapered section;
an end of the laser written waveguide comprises a second tapered section; and
the first tapered section is coupled to the second tapered section.

4. The optical assembly of claim 1, wherein:
an interface between the first end face of the interconnection substrate and the first waveguide substrate is angled with respect to an optical axis of the first waveguide of the first waveguide substrate; and
an interface between the second end face of the interconnection substrate and the second waveguide substrate is angled within respect to an optical axis of the second waveguide of the second waveguide substrate.

5. The optical assembly of claim 1, wherein the first waveguide substrate comprises an optical fiber and the second waveguide substrate comprises an active optical component.

6. The optical assembly of claim 1, wherein the laser written waveguide comprises at least one curve.

7. The optical assembly of claim 1, wherein the laser written waveguide traverses from a surface of the interconnection substrate to a midpoint of the interconnection substrate.

8. The optical assembly of claim 1, wherein an end of the laser written waveguide comprises a tapered structure increasing in diameter in a direction to the second end face.

9. The optical assembly of claim 1, wherein the laser written waveguide has a spiral shape.

10. An interconnection substrate comprising:
a first end face and a second end face; and
a plurality of laser written waveguides within the interconnection substrate, the plurality of laser written waveguides having a plurality of indices of refraction and traversing a plurality of paths within the interconnection substrate in a direction from the first end face to the second end face.

11. The interconnection substrate of claim 10, wherein the plurality of laser written waveguides have a plurality of diameters.

12. The interconnection substrate of claim 10, further comprising a pre-written waveguide extending from the first end face, wherein the plurality of laser written waveguides is optically coupled to an end of the pre-written waveguide.

13. A method of forming an optical link in an interconnection substrate comprising a first end face coupled to a first waveguide substrate comprising a first waveguide, and a second end face coupled to a second waveguide substrate, the method comprising:
determining a location of an end of the first waveguide at the first end face; and
forming, using a laser, a laser written waveguide within the interconnection substrate extending from the first end face at the location of the end of the first waveguide, wherein the laser written waveguide at least in part defines the optical link.

14. The method of claim 13, wherein the first waveguide substrate comprises an optical fiber and the second waveguide substrate comprises an active optical component.

15. The method of claim 13, further comprising determining a location of an end of a second waveguide at the second end face, wherein the laser written waveguide extends from the first end face at the location of the end of the first waveguide to the second end face at the location of the second waveguide.

16. The method of any one of claim 13, wherein:
the interconnection substrate comprises a pre-written waveguide extending from the second end face;
the method further comprises actively aligning the second waveguide substrate to the second end face of the interconnection substrate such that the pre-written waveguide is optically coupled to a second waveguide of the second waveguide substrate; and
the laser written waveguide extend from the first end face at the location of the end of the first waveguide to an end of the pre-written waveguide.

17. The method of any one of claim 13, wherein:
the interconnection substrate comprises a pre-written waveguide comprising a first pre-written waveguide end and a second pre-written waveguide end;
the method further comprises determining a location of an end of a second waveguide at the second end face; and
the laser written waveguide comprises:
a first portion extending from the first end face at the location of the end of the first waveguide to the first pre-written waveguide end; and
a second portion extending from the second end face at the location of the end of the second waveguide to the second pre-written waveguide end.

18. The method of any one of claim 13, wherein digital imaging is used to determine the location of the end of the first waveguide at the first end face.

19. The method of claim 18, wherein the digital imaging comprises Nomarski differential interference contrast imaging.

20. The method of claim 18, wherein a depth of the end of the first waveguide is determined by focus stacking.

21. The method of claim 18, wherein a depth of the end of the first waveguide is determined by white light interferometry.

22. The method of claim 18, wherein a depth of the end of the first waveguide is determined by image tomography.

23. The method of claim 18, wherein a depth of the end of the first waveguide is determined by confocal microscopy.

24. The method of claim 18, wherein a depth of the end of the first waveguide is determined by phase shift interferometry.

25. The method of claim 13, further comprising guiding light into the first waveguide.

26. The method of claim 25, wherein the laser written waveguide within the interconnection substrate fluoresces at an excitation wavelength.

27. The method of claim 25, further comprising forming, using the laser, an initial laser written waveguide configured to scatter the light, wherein the laser written waveguide is formed over the initial laser written waveguide.

28. The method of claim 25, further comprising forming a light scattering structure at an end of the laser written waveguide as the laser written waveguide is formed within the interconnection substrate.
